(19) United States
(12) Patent Application Publication
(10) Pub. No.: US 2024/0256241 A1
(43) Pub. Date: Aug. 1, 2024

(54) COMPOSABLE KERNELS

(71) Applicant: Modular, Inc., Redwood City, CA (US)

(72) Inventors: Abdul Dakkak, Renton, WA (US); Tim Davis, Los Altos, CA (US); Aman LaChapelle, Mountain View, CA (US); Chris Lattner, Los Altos Hills, CA (US); Jeff Niu, Sunnyvale, CA (US); Tatiana Shpeisman, Menlo Park, CA (US)

(21) Appl. No.: 18/427,597

(22) Filed: Jan. 30, 2024

Related U.S. Application Data
(60) Provisional application No. 63/442,742, filed on Feb. 1, 2023.

(51) Int. Cl. G06F 8/52

(52) U.S. Cl. CPC G06F 8/52

(57) ABSTRACT

A compiler for generating composable kernels. The compiler receives a kernel generator comprising a kernel parameterization and code of a set of operators written in a general purpose programming language. For each operator of the set of operators, the compiler lowers code of the each operator into an intermediate representation of the each operator in an intermediate language, determines a configuration of the each operator based on the kernel parameterization and the intermediate representation of the each operator, and generates a binary object of the each operator of a set of binary objects of the set of operators based on the configuration. The compiler composes a kernel corresponding to the kernel generator based on the set of binary objects of the set of operations and the kernel parameterization.

### CLAIM OF PRIORITY

This application claims the benefit of priority to U.S. Provisional Patent Application Ser. No. 63/442,742, filed on Feb. 1, 2023, which is incorporated by reference herein in its entirety.

### TECHNICAL FIELD

The present disclosure relates generally to compilers, and more specifically to compilers for computationally intensive code.

### BACKGROUND

Compliers are used to generate object code from high-level languages. It is desirable to generate optimized object code.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a data flow diagram of a composable kernel generation and use process, in accordance with some examples.

FIG. 2A is a block diagram of a composable kernel generation system 200a, in accordance with some examples.

FIG. 2B is a process flow diagram of a kernel generation method 200b, in accordance with some examples.

FIG. 2C is a data flow diagram of operator generation data flow of an operator generation method, in accordance with some examples.

FIG. 2D is a process flow diagram of an operator generation method, in accordance with some examples.

FIG. 2E is a data flow diagram of operator elaboration data flow of an operator elaboration method, in accordance with some examples.

FIG. 2F is a process flow diagram of an operator elaboration method 200f, in accordance with some examples.

FIG. 3A is a data flow diagram of model generation data flow of a model generation method, in accordance with some examples.

FIG. 3B is a process flow diagram of a model compilation method 300b, in accordance with some examples.

FIG. 4 is a block diagram of an authoring system, in accordance with some examples.

FIG. 5 illustrates a machine-learning pipeline, according to some examples.

FIG. 6 illustrates training and use of a machine-learning program, according to some examples.

FIG. 7 is a diagrammatic representation of a machine within which a set of instructions may be executed for causing the machine to perform any one or more of the methodologies discussed herein in accordance with some examples.

FIG. 8 is a deployment diagram for a composable kernel generation and deployment system, according to some examples.

### DETAILED DESCRIPTION

Other technical features may be readily apparent to one skilled in the art from the following figures, descriptions, and claims.

Kernel libraries provide high performance implementations of numeric and data processing algorithms, optimized to take advantage of vectors, multicore dedicated hardware blocks, and dedicated accelerators available on modern computers. Modern machine learning frameworks are typically collections of hundreds-to-thousands of these kernels—amalgamating kernels from many different sources into a consistent API that is supplemented with gradient calculation and other higher level features. These kernel libraries are responsible for the early success of frameworks like TensorFlow™ and PyTorch™, and provide a “hackable” interface to extend these frameworks: this extensibility has successfully enabled novel research as well as integration into existing legacy applications (important for data loading).

Kernel libraries have well known scalability challenges: generating a high performance numeric kernel is difficult, and takes rare experts significant time to build. Furthermore, these libraries quickly grow to include thousands of operators—this makes it difficult to bring up new hardware. Indeed, these libraries typically do not get re-tuned for new generations of hardware.

Compiler engineers have stepped up to try to solve this problem. Some systems focus on a small subset of the problem (dense linear algebra operators with static shapes) with a closed operator set with human intensive “intelligent design” of compiler heuristics. That said, some systems have successfully shown that aggressive kernel fusion, data layout optimizations, and extremely challenging accelerators are within reach of modern Machine Learning (ML) model compilers. Some systems extend ideas from other systems to provide a more flexible and extensible architecture, replacing many of these heuristics with search, providing a different design point between the kernel author and computer.

These systems have limitations related to specialization that makes it difficult to support new hardware developments and extend these systems to address a broader class of problems.

Examples of the present disclosure provide a next-generation system that breaks down these barriers, establishing a new point in the design space. One that combines a human expert's ability to reason about kernel architecture and numeric precision, while benefiting from a computer's attention to detail, and benefiting from an open architecture.

In some examples, a computer-implemented method comprises receiving, by one or more processors, a kernel generator comprising a kernel parameterization and code of a set of operators written in a general purpose programming language. For each operator of the set of operators, performing operations includes translating code of the each operator into an intermediate representation of the each operator in an intermediate language, determining a configuration of the each operator based on the kernel parameterization and the intermediate representation of the each operator, and generating a binary object of the each operator of a set of binary objects of the set of operators based on the configuration. The method further includes composing a kernel corresponding to the kernel generator based on the set of binary objects of the set of operations and the kernel parameterization.

In some examples, translating the code of the operator comprises lowering the code of the operator to a lower intermediate language.

In some examples, a computer implemented method includes receiving, by one or more processors, an input model of a computation, the model written in a high-level language, translating the code of the model into an intermediate representation in a first intermediate language, the intermediate representation comprising a set of input variables, a set of output variables, and a set of operators that translate a set of input values corresponding to the set of input variables into a set of output values corresponding to the set of output variables, and determining, by the one or more processors, a first set of operators and a second set of operators from the set of operators based on a selection criteria. The method further comprises generating, by the one or more processors, a set of optimized primitive-level buffer-semantic representations of the first set of operators, generating, by the one or more processors, a set of non-optimized primitive-level buffer-semantic representations of the second set of operators and a library of fallback operators, and composing an executable model corresponding to the input model based on the set of optimized primitive-level buffer-semantic representations and the set of non-optimized primitive-level buffer-semantic representations, the executable model in a binary executable format.

In some examples, translating the model comprises lowering the code of the model to a lower intermediate language.

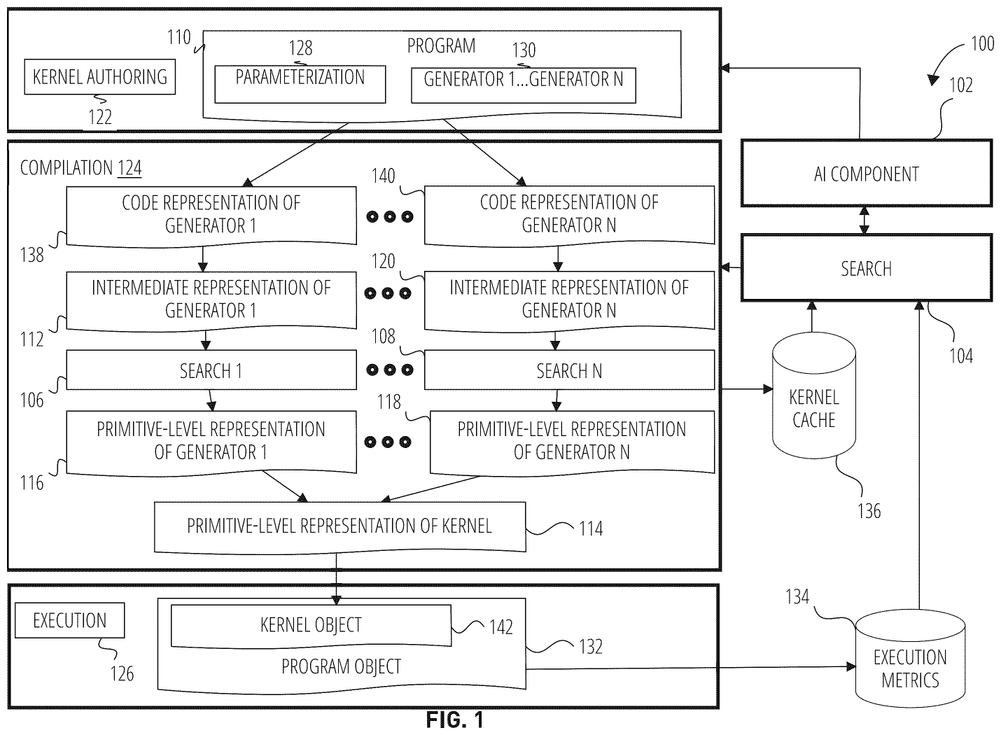

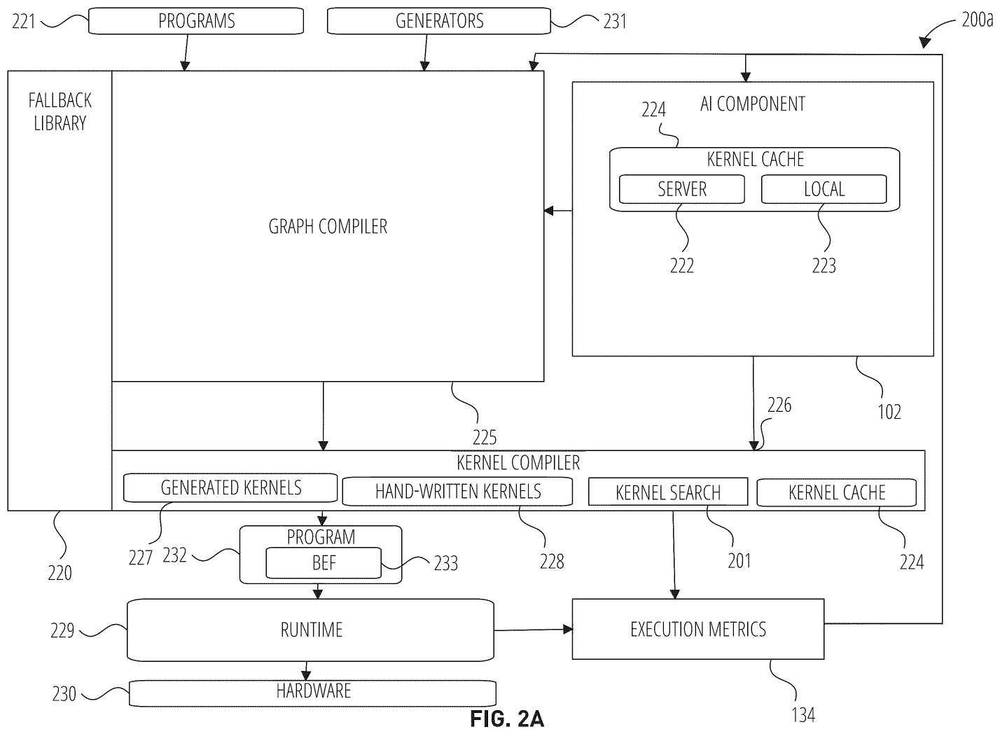

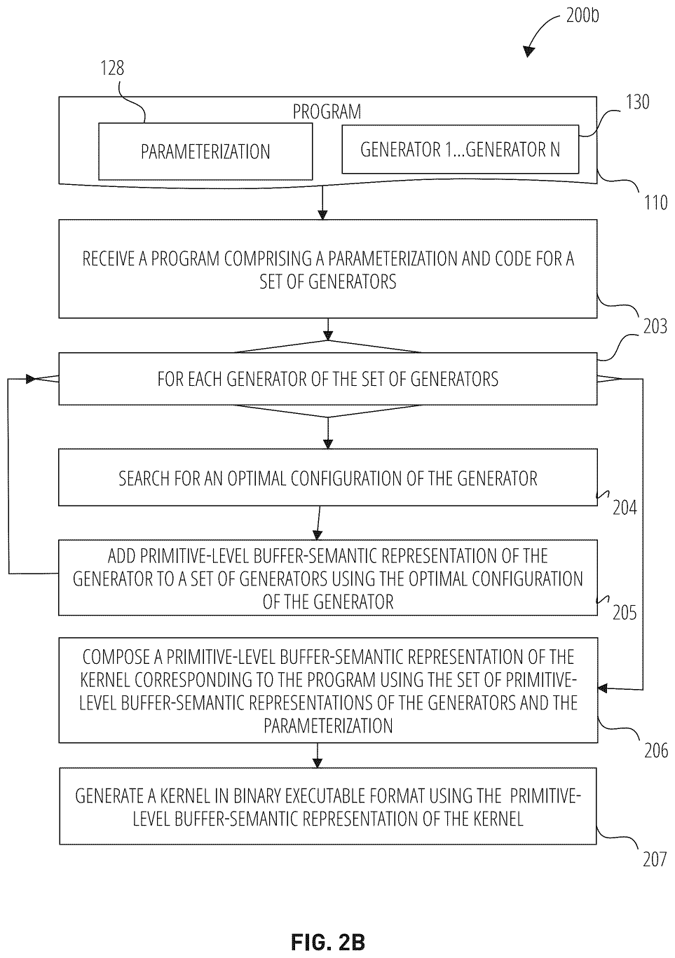

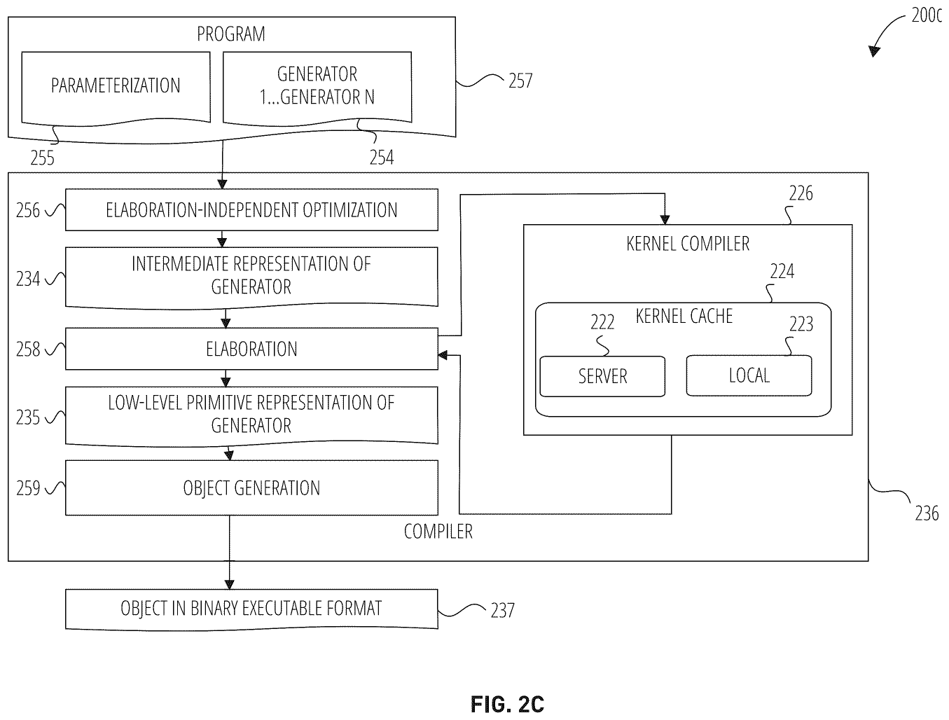

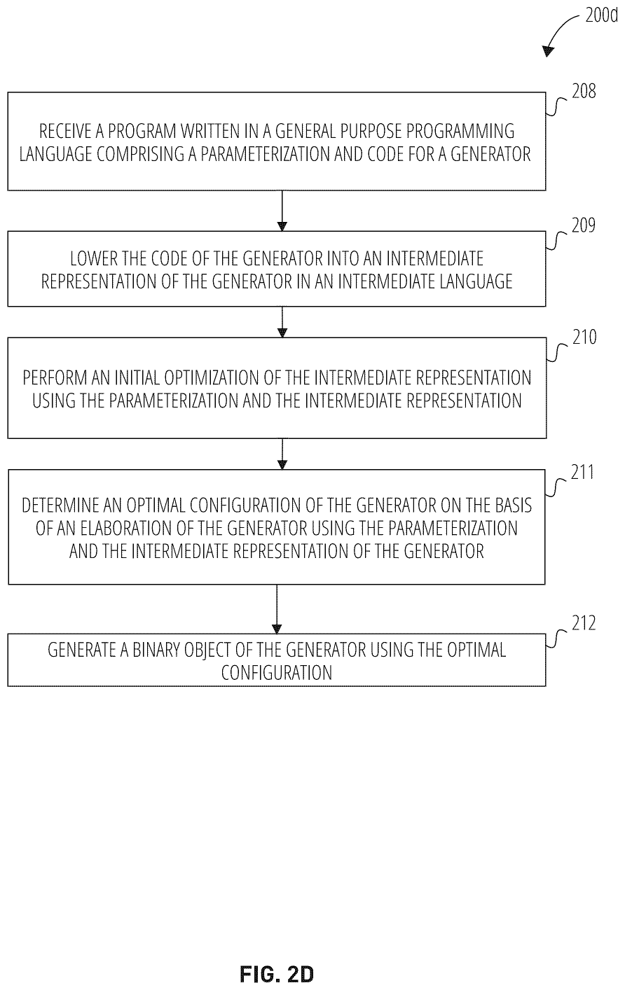

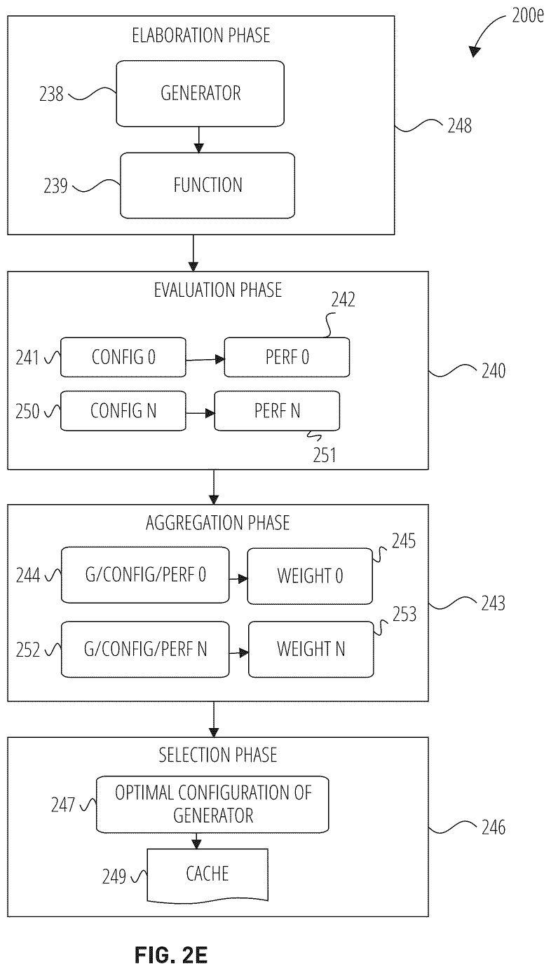

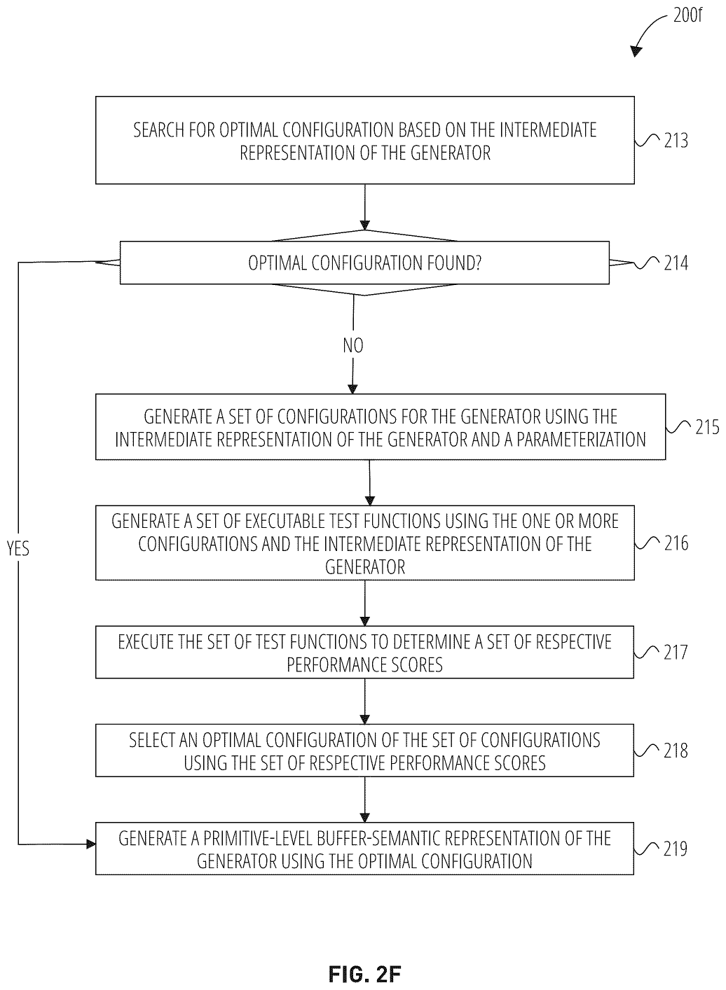

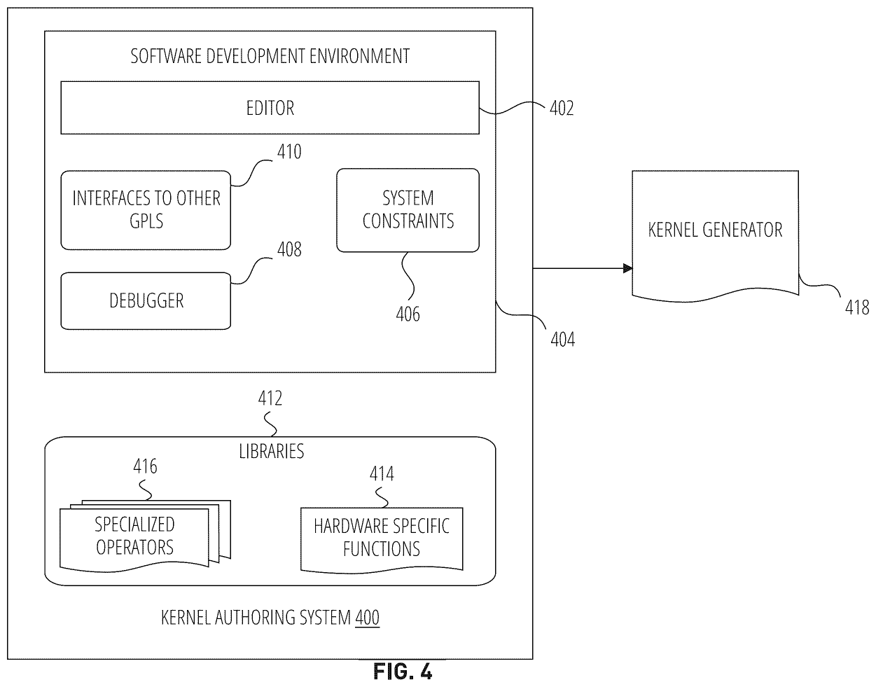

FIG. 1 is a data flow diagram of a composable kernel generation and use data flow 100 of a composable kernel generation and use process, in accordance with some examples. A software developer authors a program 110 during a kernel authoring phase 122 in a process more fully described in reference to FIG. 4. The program 110 is used to compose a primitive-level representation of kernel 114 in a compilation phase 124 as more fully described in reference to FIG. 2B, by a composable kernel generation system 200a as more fully described in reference to FIG. 2A.

The program 110 is comprised of a parameterization 128 and generator 130 for a set of operators, as illustrated by code representation of generator 1 138 and code representation of generator N 140. As used herein “operator” refers to an operator that performs an operation on one or more data buffers, and/or a function comprising one or more operators.

The parameterization 128 comprises a set of parameters that control or constrain how the program 110 generates code for the operators based on the code, how that code is compiled into operators, and how the operators are combined to form a composable primitive-level representation of kernel 114. In some examples, generator 130 is written in a general purpose programming language such as Python or the like. In some examples, the parameterization 128 is a set of kernel parameters. In some examples, the parameterization 128 is comprised of a parsable scripting language or the like that generates the kernel parameters.

During the compilation phase 124, code of an operator, such as code representation of generator 1 138 and code representation of generator N 140, is lowered from the general purpose programming language into a primitive-level representation of an operator, such as primitive-level representation of generator 1 116 and primitive-level representation of generator N 118, through a series of intermediate representations, as illustrated by intermediate representation of generator 1 112 and intermediate representation of generator N 120. During the compilation phase 124, optimal configurations of the operators are determined in a search, such as search 1 106 and search N 108 based on the parameterization 128 and the intermediate representations of the operators in a process more fully described in reference to FIG. 2F. Search results and other compilation metrics are stored in a kernel cache 136 for use during a subsequent search 104. As used herein, “search” refers to searching through a tree of possible configurations using a combination of static analysis of prior configurations and a dynamic analysis of proposed configurations performed during an elaboration process as more fully described in reference to FIG. 2F.

The primitive-level buffer-semantic representations of the operators are combined into a primitive-level representation of kernel 114. The primitive-level representation of kernel 114 is stored for later use.

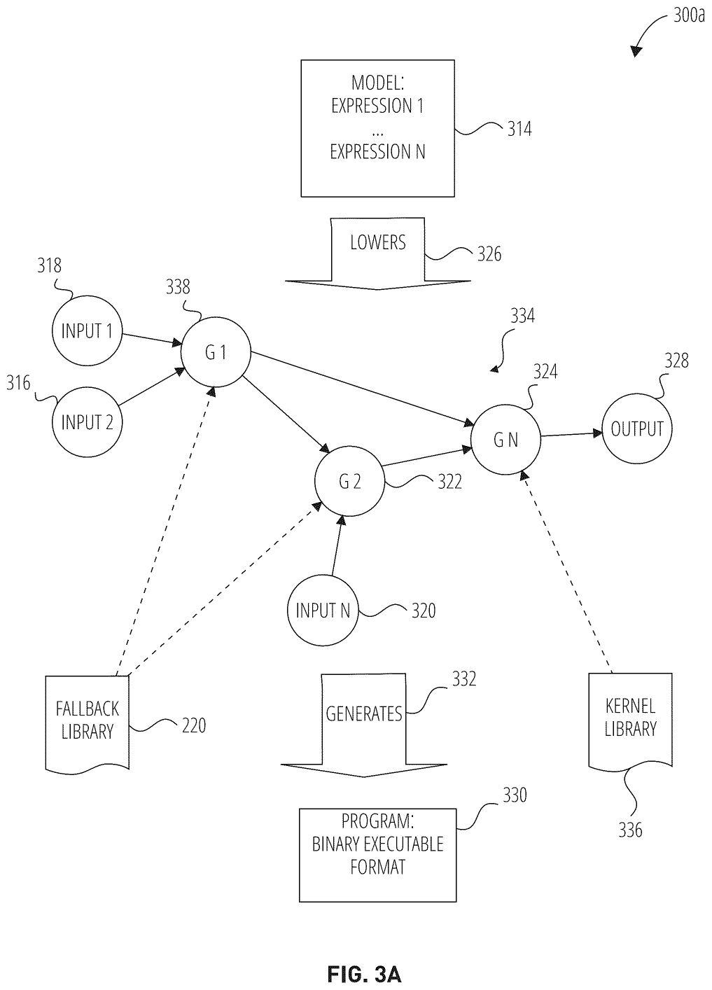

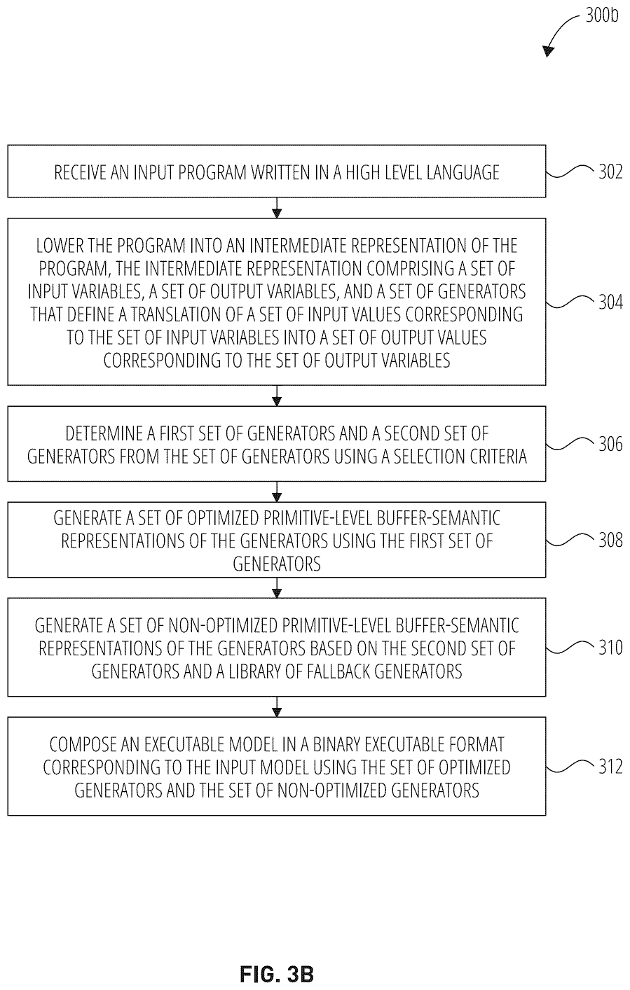

For execution, a kernel object 142 is generated and included in a program object 132. Models of a computation process use the kernel object 142 and the kernel's operators during an execution phase 126. The program object 132 is generated based on the logic of the model and a set of kernels in a process as more fully described in reference to FIG. 3A. Once generated, the program object 132 is executed during the execution phase 126 and uses the set of operators of the set of kernels to perform a computation.

In some examples, execution metrics of the kernels and their operators are stored in a datastore of execution metrics 134. The execution metrics 134 are used by a subsequent search 104 to determine an optimal configuration.

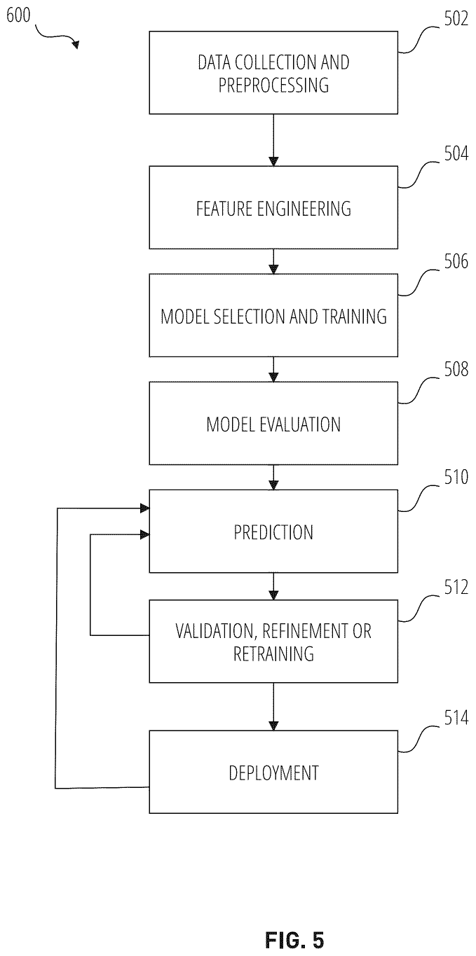

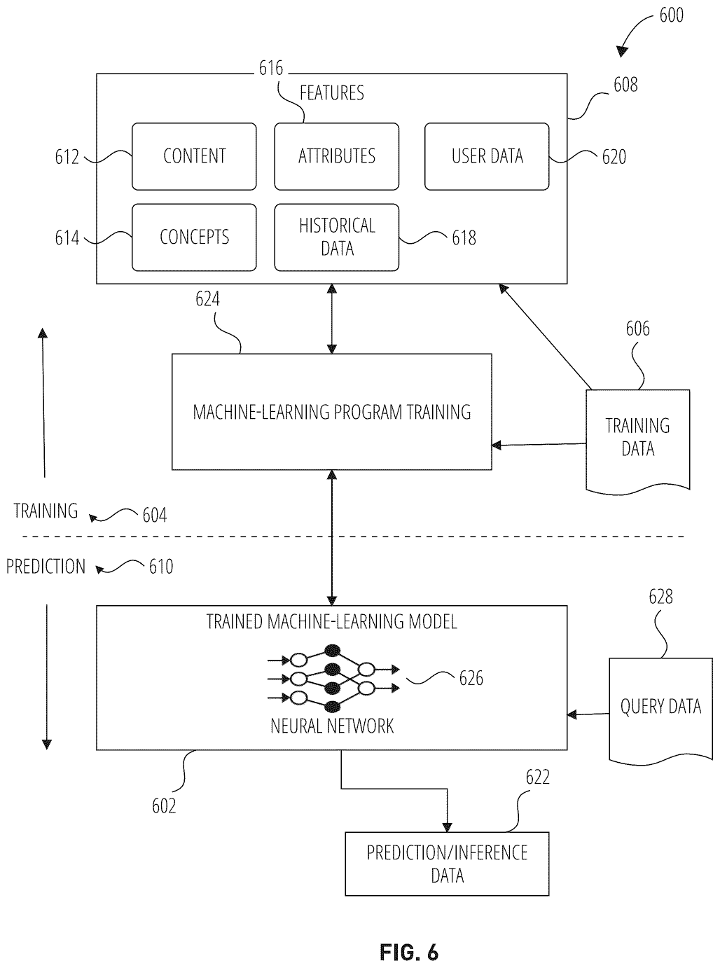

In some examples, an Artificial Intelligence (AI) component 102 is used to assist in a search. The AI component 102 comprises one or more machine learning models as more fully described in reference to FIG. 5 and FIG. 6. For example, the AI component 102 systematically evaluates various configurations and parameters during the search process to identify the most effective solutions for kernel generation. It applies machine learning techniques to predict outcomes based on historical data, thereby reducing the search space and computational resources required. The involvement of the AI component 102 enhances the precision of the search, allowing for a more targeted approach that can yield optimal or near optimal configurations with greater speed and accuracy.

In some examples, the AI component 102 also assists during a kernel authoring phase 122 during which kernels are written within a Software Development Environment (SDE) as more fully described in reference to FIG. 4. For example, the AI component 102 streamlines the kernel authoring phase by providing intelligent code completion and advanced analytics within the SDE. The AI component 102 analyzes the code being written in real-time, offering recommendations for performance improvements and identifying potential bottlenecks. The deep understanding of the AI component 102 of a kernel architecture and the ability of the AI component 102 to learn from vast datasets of kernel performance metrics allows it to guide developers towards best practices and more efficient design patterns. This proactive assistance provides for authoring kernels with correctness in mind but also provides for optimizing for the specific computational characteristics the kernels will encounter in deployment.

In some examples, operators are defined as a fusion of several other lower level operators, e.g., broadcast, activation operators, and sometimes even larger fused amalgams like Long Short-Term Memory (LSTM) operators. Describing operators at this level of abstraction simplifies high-level optimizations, extraction of shape operators, and generation of operator gradients.

In some examples, kernel generators are used to generate implementations of existing operators in existing Machine Learning (ML) frameworks (TFLite, TF, ONNX, PyTorch, etc.). Operators in existing ML frameworks have attributes such as, but not limited to, broadcasting and type promotion support, handwritten operators chosen by experts that are known to be important to certain classes of models, e.g., activation operators fused into element wise operators like “add”, support for quantized algorithms that depend on architecture-specific DSP operations, layouts assumed by existing frameworks, support for dynamic shapes and dynamic dtypes, and the like. In some examples, operators support:
Dynamic shapes
Broadcasting, type promotion: for example, “mul” is a binary operator, and the two operands can have different shapes and dtypes. ML frameworks often improve usability by providing implicit promotion to a common element type, and support broadcasting of elements.
Layout munging: some frameworks support multiple different layouts, e.g., row-major and col-major, tiled layouts, etc. When the inputs are in different formats, a conversion may be needed. Some libraries use strides to provide a common implementation that can work with many different layouts, but strides are not general to tiled layouts.
Type dispatch: standard kernel libraries work on multiple dtypes, which are only known dynamically at kernel invocation time. This requires the kernel to dynamically dispatch over the dtype and dispatch to kernels specialized for many different dtypes. Some dtypes may have special cases, e.g., “complex add” can be handled by the same code path as “scalar add” (since complex addition is element wise), but “complex mul” is a completely different algorithm than “scalar mul”.
Thread Tiling: At the outer level of the type-specific kernel algorithm, the computation is carved into blocks that can be executed in parallel by multiple threads. The size of each subunit needs to be determined, and is generally best evaluated based on hardware characteristics and size of input data (not based on #available threads).
Cache Tiling: Within the per-thread computation, the computation is typically cache blocked, e.g., at the L2 level. The size of the L2 is target specific. It may be important for algorithms that make multiple passes over the data, and less important for element-wise operations that have little reuse.
Per Tile Algorithms: Within the per-L2 tiles, there are many ways to implement the core algorithm, including with scalars, vectors, using prefetches, etc. There are also special cases that are interesting to handle when broadcasting is handled internally to the kernel, e.g., when the fastest varying dimension of one operand is broadcasted.
Many microkernels: Algorithms like matrix multiplication depend on lower-level operations like memset to clear buffers, panel dot products, reductions, etc. These “microkernels” are themselves implementable in many different ways.
Macro algorithms: Many operators have multiple completely different algorithms for computing the result, e.g., in convolution we see the im2col approach, direct convolution, Winograd. Matmul has many implementations (particularly when quantization and accelerators force weird data layouts), also including Strassen's algorithm, etc.
Hardware targets now frequently have spatial operations (like Apple AMX or Intel AMX) that can speed up multiple loop nests at a time, e.g., for matrix multiplication and large element wise blocks. They also have many architectural families that will want things register-blocked, pipelined, and unrolled differently.

In some examples, the primitive-level representation of kernel 114 is a component of a framework comprised of a set of code generated kernels that operate on memory buffers such as, but not limited to, memory operators, 1D memory arrays, tensor buffers, user defined data structures, and the like. In some examples, kernels directly use C/C++, assembly, and intrinsics for specific hardware features.

In some examples, a library of kernel components is utilized to generate kernels. For example, buffer-level kernel generators are utilized that replace legacy kernels. The kernel components will be modular and reusable, including core algorithms such as, but not limited to, memory fills, reductions, element wise operators, etc. in addition to more specialized primitives used in quantized kernels and other domains.

In some examples, kernel generators are parametric kernel generators. It is difficult for humans to create and maintain all permutations of a kernel by hand (e.g., for all dtypes, all target machines etc.), so they pervasively turn to meta programming. This meta programming comes in a variety of forms, for example C macros and ifdefs, Python generator frameworks, “emitters” written in C++ against “IRBuilder” compiler APIs, but the most widely used are C++ templates.

In some examples, kernels are defined as declarative kernel generators that take kernel parameters and have arbitrary imperative logic coded against them that is “burned into” the generated code for a kernel. This can be used to specialize on things like the dtype, unroll factors, vector lengths, cache sizes etc. Most parameters have integer type and are bounded by range (e.g., unroll <=8 times), a list of valid values (e.g., vector length=2, 4, 8, 16, 32), and should support enums (e.g., consider dtype), which makes them searchable. Using kernel generators still permits use concrete kernels (e.g., a fixed blob of assembly) since they are a valid generator with no parameters (or, equally, fully constrained parameters).

Example code is illustrated below. A kernel may have parameters bound at its invocation site, e.g., after a dynamic switch on dtype, the next—level down microkernel is invoked with a dtype parameter bound to a constant value:

```
// This fills a 1D buffer with unknown length but
known dtype with ones.
kgen.generator.interface
@fillWithOnesFixedDType<type: dtype>(%dest: !meta
.buffer<?xtype>)
// Fills a 1D buffer with unknown length and
unknown dtype with ones.
kgen.generator @fillWithOnes(%dest: !meta.buffer<
?x?>) {
  %dtype
= meta.buffer.dtype %dest : !meta.buffer<?x?>
  scf.switch %dtype { // dynamic switch
  case f32:
    %dstCast = meta.buffer.cast %dest
: !meta.buffer<?x?> to buffer<?xf32>
kgen.call @fillWithOnesFixedDType<type: dtype = f
32>(%dstCast)
  case i32:
    %dstCast = meta.buffer.cast %dest
: !meta.buffer<?x?> to buffer<?xi32>
kgen.call @fillWithOnesFixedDType<type: dtype = i
32>(%dstCast)
  case i8:
    %dstCast
= meta.buffer.cast %dest : !meta.buffer<?x?> to b
uffer<?xi8>
kgen.call @fillWithOnesFixedDType<type: dtype = i
8>(%dstCast)
  // . . .
  }
}
```

In some examples, given a uniform representation for dynamic values as well, a kernel generator provides for layering in value specialization when attributes of input arguments are statically known to the kernel generator. For example, when generating a specialized version of a kernel for f32 type, the “meta.buffer.dtype” operation and the “scf.switch” op can be constant propagated. More elaborate value propagation can be used to propagate sets (e.g., specialize on f32 and i8, removing other dtypes) if there is a reason to.

In some examples, an aspect of parameterized generators is that they rely on types to be parameterized based on expressions derived from generator parameters. This is not just for types like ‘buffer’, but also for things like SIMD vectors length/dtype and scalars with parametric type as illustrated below:

```
kgen.generator @fillWithOnes<type: dtype, vecLen>
(%dest: !meta.buffer<?xtype>)
  // Better handled as a “simd length” type to
avoid repeating in each kernel.
  constraints <vecLen ∈ [2,4,8,16,32]>
{
  %bufferLen = meta.buffer.size %dest
: !meta.buffer<?xtype>
  // Parameters are not SSA values, but can be
projected into them explicitly.
  %vecLen = kgen.param.value : index = <vecLen>
  %ones = kgen.call @simd_splat<veclen, type> 1
: !simd<veclen x type>
  scf.for i = 0 ... %bufferLen step %vecLen {
    %simdPtr
= meta.buffer.cast %dest[%i] to simd<. . .>
    kgen.call @simd.store <. . .> (. . . %ones −
> %simdPtr)
  }
  // Cleanup loop
  %one = kgen.call @scalar_constant<type>(. . . 1
. . .)
  scf.for i = (%bufferLen/%vecLen) *%vecLen
... %bufferLen {
    kgen.call @scalar.store <. . .> (. . . %ones −
> %dest[%i] . . .)
  }
}
```

In some examples, kernel generators are partial operators, and they are allowed to fail during generation time. This just removes a candidate from the set of implementations that is explored by search. If no implementations are available for an operator for a given target, then that needs to be solved at a higher level, e.g., by graph partitioning the accelerator vs. host computation.

In some examples, parameter results are used to pass meta-programmed values back up to the invoker. For example, a panel dot product microkernel is an ingredient used in matrix multiplication implementations. Panel dot may be implemented in target-specific ways using low-level vector register blocking, DSP instructions, and target-specific instructions, as exemplified by the following example:

```
// Return up the height/width of the memory block
processed by the kernel.
kgen.generator.interface @panelDotInner<( ) −
> height, width>
  (%src1: !meta.buffer<. . .>, %src2, %dest /*some
buffers*/)
kgen.generator @panelDotFullBuffer (%src1: !meta.b
uffer <. .>, %src2, %dest /*some buffers*/) {
    // Note we refer to parameter results “before
they are defined”. See
    // “order of generator evaluation” subsection
below.
    %x_step = meta.param.value<tileWidth> : i32
    %y_step = meta.param.value<tileHeight> : i32
    scf.for %i = 0 ... % width step %x_step {
      scf.for %j = 0 ... % height step %y_step {
        kgen.call @panelDotInner<( ) −
> tileHeight, tileWidth>(...)
      }
    }
    // cleanup code.
}
```

In the example above, the parameter results of the panelDotInner generator invocation are used lexically before the invocation itself. The generated primitive-level representation of kernel 114 is a traditional imperative program that is eventually received into another system for code generation, but the metaprogram is not. The metaprogram is interpreted by the compiler framework at kernel generation time, and it does not need to execute things in the lexical order specified by the kernel. Instead, the position in the kernel is used to indicate where the generated code (or a call to it) is inserted related to the other code in the kernel: it is an insertion point for a builder.

This makes the order of evaluation of the generators quite flexible: the generator is valid if there is a valid topological ordering to the generator invocation (thus, cycles are invalid). For example:

```
kgen.generator @something<inParam −
> result>(%data: !meta.buffer<128xf32>) {
  kgen.call @subKernel1<intermediate −>
result>(% data: buffer<128xf32>)
  kgen.call @subKernel2<inParam −
> intermediate>(%data: buffer<128xf32>)
}
```

The eventual intermediate representation generated by @subKernel1 will be executed before the eventual intermediate representation generated by @subKernel2, but the generator for @subKernel2 will be run before the generator for @subKernel1 because of the dependence on the intermediate parameter that needs to be computed.

Furthermore, in this example:

```
kgen.generator @something<inParam −
> result>(%data: buffer<128xf32>) {
  kgen.call @subKernel1<inParam −
> result>(%data: buffer<128xf32>)
  kgen.call @subKernel2<inParam −
> result2>(%data: buffer<128xf32>)
  % t1 = meta.param.value : i32 = <result>
  % t2 = meta.param.value : i32 = <result2>
  ...
}
```

There is no dependence between the two generators, so a compiler can generate them in parallel. This structure (along with the general tree/forest/DAG structure of the computation) contributes to a compilation process for kernels having parallelism that may be exploited to speed up kernel generation on multicore machines.

In some examples, kernels are defined with domain- and target-specific abstractions. One simple example is the “panel dot product” microkernel above. This is domain specific (to matrix multiplications) with lots of details specific to how it is used, and also its implementations are often widely target specific—one can use a parametric intermediate representation generator to produce them, but will also want to use inline assembly and implementations using target specific intrinsics. As discussed above, ML operators are multilevel with lots of complex implementations at many levels of abstraction.

In some examples, kernel authors declare their own abstractions, as in C++. To do so, a composable kernel generation system 200a provides for declaring interfaces to (micro) kernels, and supports having many different implementations for each micro-kernel—each of which implements the common interface. Each kernel may be defined recursively based on simpler smaller kernels, which can themselves have multiple different implementations.

In some examples, the interface declaration stands alone from the implementations, allowing clients to call into them and type check that the implementations obey the intended API. This provides type checking, but also a framework in which the composable kernel generation system 200a can reason about many different implementations of the same algorithm (typically with different tradeoffs/constraints, specialized to an architecture etc.).

In some examples, the composable kernel generation system 200a provides natural ways to abstract runtime interfaces and other concerns. For example, a “parallel for loop” kernel can be expressed and implementations provided defined in terms of different targeted runtimes (e.g., OpenMP instead of LLCL).

In some examples, there are multiple available implementations of each kernel, microkernel, operator, and operator, the composable kernel generation system 200a determines which one is optimal for a given target and scenario (dtype, size class etc.). Accordingly, a (micro)kernel interface declaration defines a cost model that is optimized by search (e.g., find configuration of an implementation with the “best achieved FLOPS”). For example, an implementation of a microkernel may include using scalar operations, implemented with SIMD operators of multiple different lengths, a few implemented in inline assembly, and maybe one implemented with Apple AMX. The composable kernel generation system 200a selects a configuration for implementation with the highest throughput for the current hardware, empirically, by measuring it (implementations for incompatible systems are ignored as infinite cost).

In some examples, search is enabled by building up a large collection of models that use the operators in realistic ways. This allows the composable kernel generation system 200a to collect data of execution metrics 134 about the right tensor input sizes to measure against (using realistic input dimensions instead of random ones) similar to the mmperf “benchmark sizes” lists. In some examples, a profile is collected and used, or certain dimensions are weighted more heavily to achieve goals like “prioritize MLPerf performance” or “generate best possible code for one model,” depending on any particular product's goal.

In some examples, given dimensions weighting for top-level operator kernels, the composable kernel generation system 200a can propagate them down the tree of expansions into microkernels—for example, a microkernel that does broadcasting of tensor data into a buffer can be generated knowing all the most common dimensions being input from the kernel that uses it. If the composable kernel generation system 200a chooses to emit a kernel like this out-of-line (to reduce code size vs. inlining it) then the composable kernel generation system 200a can aggregate expected input dimensions from all the different kernels that call into it.

In some examples, parameters of the parameterization 128 are unspecified. These parameters are explored and determined by the composable kernel generation system 200a during a search. For example, the composable kernel generation system 200a determines a number of iterations that will fit in a cache, and the composable kernel generation system 200a returns the result as a parameter result, allowing the enclosing generator to tile or parallelize around that. As another example, given an element-wise multiply microkernel implemented in terms of vectors over a 1D block of memory, a loop utilizing one of these low level operators will increase in FLOPS until the L2 cache is exceeded, at which point a cache blocked algorithm above will typically be more efficient. Allowing the kernel to define the metric (e.g., FLOPS) will allow the use of search to find the right implementation. Top level operator kernels can use latency as their metric.

In some examples, as some generator parameters (e.g., dtype) are defined on the generator interface (and thus common to all implementations), the composable kernel generation system 200a provides for implementations of a kernel generator to have additional parameters as well (e.g., an ARM implementation of a kernel providing three implementations of the same operator for different microarchitectures). This would be sugar for “flattening” these parameters as different individual implementations of the same microkernel.

In some examples, there are multiple implementations of each micro-kernel, which are then implemented in terms of other interfaces which may have many implementations. These expansions form a tree of possible expansions, and, as there may be many top level operators in the framework, there is a forest of expansions to work with at many levels of abstraction. For example, a matrix multiplication microkernel can be implemented with a three-level for loop, with cache blocking, and with internal L2 tiling. It may also be implemented it to use target specific dot product operations, and with 2D operators and common accelerators. Each of these may be implemented in independently of each other, all implementing the same interface. Each “tree of expansions” may have an exponential number of expansions possible for a single framework operator. This makes it impractical to search the entire space for a single kernel, and even more challenging to support an entire ML framework—particularly when a single framework may have hundreds/thousands of individual kernels.

In some examples, human-authored constraints are defined on the kernels to cut off the search space or guide the exploration as a basic bound in parameter declarations. In some examples, conditional constraints are provided. In some examples, redundancy in the tree-based structure is exploited with dynamic programming techniques. Dynamic programming uses memoization/caching of subproblems to algorithmically improve the performance of hierarchical tree-based algorithms. In some examples, each tree of expansions will have a lot of common leaves, and a forest will have many shared leaves, subtrees, and potentially entire kernels. By allowing a cost model to be defined at many levels (not just at the top level framework operator), the composable kernel generation system 200a exploits modularity for searches and can caches the results. The use of dynamic programming collapses the “expansion tree” into a Directed Acyclic Graph (DAG).

In some examples, a cache is hosted on a cloud service, providing an oracle for users so they get search offline. This allows users to avoid full search algorithms on their device. In some examples, the composable kernel generation system 200a generates analytics on what users are using the composable kernel generation system 200a for. In some examples, an install size for a mobile framework may be very small, instead of shipping a typical kernel library with lots of bloated kernels, a provider of a composable kernel generation system 200a ships a Just In Time (JIT) compiler that can generate the kernels. A user might not want to do a search on their device, so a provider of a composable kernel generation system 200a can either bundle a binary blob with the application or add logic to download the right kernel parameters for the target hardware and generate/cache machine code for the kernels at app install time, using the compiler as a “compression scheme” to reduce the download size impact of the kernel library.

In some examples, a provider of a composable kernel generation system 200a takes the “most frequently used” results and compiles them into a binary blob, shipping it with a framework. This ensures the most common things (e.g., all the BERTs) are always a cache hit. In some examples, searching offline and using metrics to provide additional services to users is extended to higher level problems like operator fusions etc.

In some examples, each level of kernel generator tree expansion is functional (side-effect free), and the “key” used to look up the computation is encodable in a way the composable kernel generation system 200a can hash and lookup (e.g., the key is a blob of serialized MLIR). This is important anyway for parallelizing the tree compilation (tree/DAGs have a lot of parallelism).

In some examples, kernel fusion of arbitrary element-wise computation into matrix multiplication is enabled. The composable kernel generation system 200a supports this by allowing kernel generators to be parameterized by regions. Regions are just a different form of parameter argument, where a body of code is passed down and is accessible to meta programming constructs. For example, exposing regions as a general feature in the composable kernel generation system 200a system allows for operations such as “switch on dtype” and “statically unroll the loop based on this parametric expression” to be defined in the system itself, rather than being hard coded into the system. This allows the composable kernel generation system 200a to be user-extensible as nothing in the stack is specific to dense linear algebra, users can build their own library of generators that partition work against tables of data or trees, talk to their own foreign storage (e.g., databases and the like), and the like.

In some examples, parameterized generators also lead to a natural expansion in the expressivity of the ML operator graph abstractions. Instead of tfl.conv2d having an enum of activations, conv can take a region that does elementwise computation on scalars, allowing arbitrary elementwise operators to be fused in—at the graph level. This allows the composable kernel generation system 200a to implement kernel fusion through graph rewrites which get lowered to generators in a predictable way.

In some examples, the composable kernel generation system 200a utilizes algorithmic skeletons allowing describing higher order transformations that enable encoding parallel patterns in a reusable way as an implementation task is simplified by the fact that each skeleton may be considered independently, in contrast to the monolithic programming interfaces of existing systems at a similar level of abstraction.

In some examples, kernel generators are allowed to be partial operators from the interface declaration to a concrete implementation. Constraints indicate limitations on their parameters, e.g., “this implementation only works with dtype=float32”, or “this only works on machines with X86 VNNI extension”, this “works for sizes modulo 128”, and the like. In some examples, are upward propagated from kernel implementations out to the operator graph.

In some examples, the composable kernel generation system 200a generates and captures a large amount of data and can even have “importance weights” on the data. Given this data, ML models are built for kernels that generalize from data the composable kernel generation system 200a has seen to handle unknown situations the composable kernel generation system 200a has not. In some examples, the captured data is supplemented with randomly synthesized kernels (e.g., novel fusions) for directed learning. This allows the composable kernel generation system 200a to be extremely efficient and nice for things the composable kernel generation system 200a knows are important, while also generalizing to new hardware in an efficient manner.

In some examples, the composable kernel generation system 200a uses kernel descriptions in intermediate representation form, a machine analyzable/transformable format. In some examples, the composable kernel generation system 200a extracts shape operators for operators by using code slicing to extract the computation from the kernel description. This ensures that the composable kernel generation system 200a has a single source of truth for kernels+shape operators.

In some examples, the composable kernel generation system 200a derives the “what ops+dtypes are supported by this target” set from a kernel library statically, and encodes that data into a table that is used by the device graph partitioner. This keeps a single source of truth, instead of redundantly encoding this in the graph partitioner. This allows a user to progressively implement a few micro kernels for a new target and have the operator set start lighting up incrementally.

In some examples, the composable kernel generation system 200a detects an “invocation independent computation”, e.g., a lookup table that only depends on known-constant-at-the-graph-level operator attributes. This computation can be automatically sliced out of the main kernel computation into a “prepare-like” operator that computes the lookup table into a custom struct at initialization time, rather than computing it every invocation of the kernel.

In some examples, the composable kernel generation system 200a implements “kernel generators” with a Multi-Level Intermediate Representation (MLIR) compiler APIs to provide structures that are more complex than parameterized expansions. Operators are encoded as compiler transformations and provide a flexible programming model to users. These are generators that take a region of an intermediate representation as a parameter and produce a new one.

In some examples, the composable kernel generation system 200a generates backwards versions of kernels automatically.

In some examples, the composable kernel generation system 200a extracts metadata about the operations, e.g., whether they are associative, side effectful, etc.

In some examples, the composable kernel generation system 200a synthesizes versions of the kernels for other considerations, e.g., code size. This can be useful for constant folding operators within the compiler.

In some examples, the composable kernel generation system 200a generates a specialization of kernels and operators using static data of a model. For example, if a model only uses float32 or int8, the composable kernel generation system 200a strips away all the support for other dtypes, producing a much thinner kernel library. This can be useful for deployment considerations as well as reducing instruction cache pressure (improving performance). The 200a can specialize when shapes are statically known as well.

In some examples, the composable kernel generation system 200a canonicalizes complex framework-specific operators into simpler framework agnostic region-parameters operators.

In some examples, kernels generated by the composable kernel generation system 200a take output buffers as arguments that may not be exposed into the graph. The composable kernel generation system 200a provides for a “buffer exposed” graph-level representation that allows memory planning, in-place optimizations for concatenation, and the like.

In some examples, the composable kernel generation system 200a takes metadata of buffer-level operator implementations and reflects it back up to the operator graph level.

In some examples, the composable kernel generation system 200a is target independent and scales to CPUs and many accelerators. In some examples, the composable kernel generation system 200a is ML framework independent, separating all integration issues out and focusing on kernel generation only. In some examples, the composable kernel generation system 200a is not specific to one memory layout or other narrow set of assumptions. In some examples, the composable kernel generation system 200a is not ML or dense linear algebra specific, it supports a wide range of data types and problem domains. For example, the composable kernel generation system 200a can be used to build high performance audio for processing audio signals or data kernels for use in database platform.

In some examples, the composable kernel generation system 200a is extensible by users without having access to compiler source code.

In some examples, the composable kernel generation system 200a employs a Python-like that is a user-extensible hybrid declarative/imperative programming language that allows expressing arbitrary MLIR operator graphs in a usable way.

FIG. 2A is a block diagram of a composable kernel generation system 200a, and FIG. 2B is a process flow diagram of a kernel generation method 200b, in accordance with some examples. A composable kernel generation system 200a generates kernels based on generators 231, such program 110 of FIG. 1. The composable kernel generation system 200a also uses generated kernels 227 and hand-written kernels 228 to generate programs 232 in a binary executable format (BEF) 234 based on programs 221. The composable kernel generation system 200a uses a kernel generation method 200b to generate a kernel and its operators, and uses a model compilation method 300b of FIG. 3B to generate models.

In some examples, a program 232 in a binary executable format 233 executes during a runtime 229 on a set of hardware 230 devices and generates execution metrics 134 that are used to optimize kernels in a process more fully described in reference to FIG. 2D.

Although the kernel generation method 200b depicts a particular sequence of operators, the sequence may be altered without departing from the scope of the present disclosure. For example, some of the operations depicted may be performed in parallel, in a different sequence, or a different component of a composable kernel compilation system, such implementations do not materially affect the operator of the elaboration process. In other examples, different components of an example device or system that implements the composable kernel generation system 200a may perform operations at substantially the same time or in a specific sequence.

In operation 202, the composable kernel generation system 200a receives a program 110 comprising a parameterization 128 and generator 130 for a set of operators. In some examples, the code comprises codes of the operator written in a general purpose programming language.

In operations 203 and 204, the composable kernel generation system 200a, for each operator, determines an optimal configuration of the operator based on the parameterization 128 in a process more fully described in reference to FIG. 2D. During the process of determining the optimal configuration, the composable kernel generation system 200a generates a primitive-level buffer-semantic representation of the operator.

In operation 205, the composable kernel generation system 200a adds the primitive-level buffer-semantic representation of the operator to a set of primitive-level buffer-semantic representations of the operators. The set of primitive-level buffer-semantic representations of the operators are used to compose primitive-level buffer-semantic representation of a kernel.

In operation 206, the composable kernel generation system 200a composes primitive-level buffer-semantic representation of kernel corresponding to the input kernel generator based on the set of primitive-level buffer-semantic representations of the operators. For example, the composable kernel generation system 200a takes the set of primitive-level buffer-semantic representations of the operators and code slices the primitive-level buffer-semantic representations of the operators and their dependencies into a single module or kernel.

In operation 207, the composable kernel generation system 200a lowers the single module to an object (.o) file and stores the object file of the kernel in a datastore of generated kernels 227. In some examples, the object file has a format of an object file that a standard C-style toolchain would produce, and so works seamlessly with stacks that implement a C/C++ Foreign Operator Interface (FFI).

FIG. 2C is a data flow diagram of compiler data flow 200c of an operator generation method 200d, in accordance with some examples, FIG. 2D is a process flow diagram of the operator generation method 200d, FIG. 2E is a data flow diagram of operator elaboration data flow 200e of an operator elaboration method, and FIG. 2F is a process flow diagram of an operator elaboration method 200f, in accordance with some examples. A composable kernel generation system 200a uses an operator generation method 200d and an operator elaboration method 200f to generate an operator of a composable kernel. Although the operator generation method 200d and the operator elaboration method 200f depict a particular sequence of operations, the sequence may be altered without departing from the scope of the present disclosure. For example, some of the operations depicted may be performed in parallel, in a different sequence, or a different component of a composable kernel compilation system, such implementations do not materially affect the operator of the elaboration process. In other examples, different components of an example device or implementation of the composable kernel generation system 200a may perform operations at substantially the same time or in a specific sequence.

In operation 208, the composable kernel generation system 200a receives or accesses a compiler 236 comprising a parameterization 255 and generator 254 written in a general purpose programming language.

In operation 209, the composable kernel generation system 200a translates the code of the operator 254 into an intermediate representation of the operator 234 in an intermediate language. For example, the composable kernel generation system 200a comprises a graph compiler 225 that imports an operator generator and generates the intermediate representation of the operator 234 of the function based on the code of the operator 254. The intermediate representation of the operator 234 of the operator is a representation of the operator in an intermediate language. In some examples, the intermediate representation of the operator is in a library target format. In some examples, the intermediate representation of the function is in a form of a directed graph that represents the computation process of a model or the logic of an operator. The composable kernel generation system 200a translates the code of the operator 254 by performing a set of compiler passes on the code of the operator 254 including, but not limited to, parsing the code of the operator 254 and translating the code of the operator 254 from the general purpose programming language into an intermediate language. In some examples, the intermediate representation is in a lower intermediate language between the general purpose programming language and object code of an executable operator. In some examples, the intermediate representation is a graphical representation of the code of the operator 254. In some examples, translating the code of the operator 254 comprises lowering the general purpose programming language into a lower level intermediate language.

In operation 210, the composable kernel generation system 200a performs an initial optimization of the intermediate representation of the operator 234 based on the parameterization 255 and the intermediate representation of the operator 234. For example, the composable kernel generation system 200a uses graph compiler 225 to perform a static analysis of the intermediate representation of the function to determine portions of the intermediate representation of the operator 234 that can be optimized by expanding loops and the like. The composable kernel generation system 200a uses the parameterization 255 to determine what types of optimizations can be performed such as, but not limited to, by a maximum number of loop iterations that can be expanded, and the like.

In operation 211, the composable kernel generation system 200a uses a kernel compiler 226 to determine an optimal configuration of the operator on the basis of an elaboration of the operator based on the parameterization 255 and the intermediate representation of the operator 234 in a process more fully described in reference to FIG. 2E and FIG. 2F.

In operation 212, the composable kernel generation system 200a generates a primitive-level buffer-semantic representation 235 based on the optimal configuration. In some examples, the composable kernel generation system 200a caches the primitive-level buffer-semantic representation 235 for later analysis.

In some examples, the composable kernel generation system 200a lowers the primitive-level buffer-semantic representation 235 into an object in binary executable format 237.

FIG. 2E is an illustration of a data flow diagram of operator elaboration data flow of an operator elaboration method, and FIG. 2F is a process flow diagram of an operator elaboration method, in accordance with some examples. A composable kernel generation system 200a uses the operator elaboration method 200f to generate permutations of configurations of operators that are evaluated by the composable kernel generation system 200a to determine an optimal configuration of an operator. Although the operator elaboration method 200f depicts a particular sequence of operations, the sequence may be altered without departing from the scope of the present disclosure. For example, some of the operations depicted may be performed in parallel, in a different sequence, or a different component of a composable kernel generation system 200a, such implementations do not materially affect the operator of the elaboration process. In other examples, different components of an example device or implementations of the composable kernel generation system 200a may perform operations at substantially the same time or in a specific sequence.

In operation 213, the composable kernel generation system 200a uses a kernel compiler 226 to search for an optimal configuration of a function 239 based on an evaluator associated with the generator 238. The kernel compiler 226 is capable of performing a static analysis search and a dynamic analysis search for an optimal configuration of an operator. In a static analysis search, the kernel compiler 226 uses a kernel search 201 component to search through several different types of datastores. One type of datastore is a kernel cache 224 containing recently generated operators that can be reused by the kernel compiler 226 to generate the operator. The kernel cache 224 can be local 223 or distributed across remote storage nodes on one or more servers 222. For example, the composable kernel generation system 200a maintains a datastore of optimal configurations in a kernel cache 224. The kernel search 201 component looks for an optimal configuration for the operator based on the evaluator which is a metric by which the composable kernel generation system 200a decides which implementation or configuration is optimal.

In operation 214, the composable kernel generation system 200a determines if an optimal configuration found during the search of the kernel cache 224.

In response to determining that an optimal configuration of the operator was not found during the static analysis search, the kernel compiler 226 performs a search using a dynamic analysis of the operator. To do so, in operation 215, the kernel compiler 226, in an elaboration phase 248, generates a set of configurations, such as configuration 0 241 and configuration N 250, based on the intermediate representation of the operator 234 and the parameterization 255.

In operation 216, the composable kernel generation system 200a generates a set of executable test operators based on the one or more configurations.

In operation 217, in an evaluation phase 240, the composable kernel compilation system executes the set of test operators to determine a set of respective performance scores, as represented by performance score 0 242 for configuration 0 241 and performance score N 251 for configuration N 250. For example, the composable kernel compilation system executes each test operator and monitors the test operator's performance as the test operator operates on a test suite of data. In some examples, the performance score comprises an initialization score indicating an amount of time used by the test operator during an initialization of the test operator. In some examples, a performance score comprises an execution score indicating an amount of time that the test operator takes to operate on the test data set. In some examples, the performance score includes an amount of time that a test operator communicates with other operators of a kernel during execution.

In operation 218, in an aggregation phase 243, the kernel compiler 226 selects an optimal configuration of the set of configurations based on the set of respective performance scores. For example, the kernel compiler 226 assigns a weight to each set of operator, configuration, and performance data, such as weight 0 245 assigned to the set of operator, configuration, and performance evaluation data 0 244 and weight N 253 assigned to operator, configuration, and performance evaluation data N 252. In a selection phase 246, the kernel compiler 226 selects a configuration of an optimal configuration of generator 247 based on the sets of function, configuration, and performance evaluation data and their associated weights. The kernel compiler 226 caches the optimal configuration in a cache 249 for later search processes.

In operation 219, the composable kernel generation system 200a generates a primitive-level buffer-semantic representation of the function based on the optimal configuration.

In some examples, generating the set of configurations is further based on a target machine parameterization.

In some examples, the set of test operators are executed on a plurality of machines.

In some examples, wherein the set of test operators are executed on a plurality of machines.

In some examples, the performance scores include a set of an execution time and a loading time.

In some examples, generating the set of test operators includes selecting a library of operators from a set of libraries based on the each configuration, and generating a test operator of the set of test operators based on the selected library and each configuration.

In some examples, wherein the set of libraries includes a set of user-defined libraries and a set of system-defined libraries.

In some examples, wherein the operators defined in the set of libraries are stored in an intermediate language.

In some examples, wherein the operators are initially defined in a programming language other than the general purpose programming language and lowered to the intermediate language.

In some examples, the optimal configuration is cached in a datastore.

In some examples, the datastore is searchable based on the operator parameterization and the target machine parameterization.

In some examples, determining the configuration of the operator includes searching the datastore based on the kernel parameterization and the target machine configuration to find the optimal configuration.

In some examples, the datastore is distributed across multiple storage nodes and the searching is performed on the distributed storage nodes.

In some examples, a set of runtime performance data collected from a set of executed operators during execution is stored in the datastore where each executed operator associated with a known configuration and a known operator parameterization.

In some examples, the performance data includes communication data of communications between a subset of the executed operators.

In some examples, determining a configuration of the operator includes determining a configuration using a machine learning model trained on a set of runtime performance data collected from a set of executed operators during execution, where each executed operator is associated with a known configuration and a known parameterization.

In some examples, translating the code of the operator, determining the configuration, generating the executable operator, and composing the kernel are performed on two or more machines.

In some examples, the kernel is stored in a datastore accessible through a network.

In some examples, the kernel is combinable with other kernels in a kernel library.

FIG. 3A illustrates a data flow diagram of model generation data flow 300a during a model compilation process, and FIG. 3B illustrates a model compilation method 300b, in accordance with some examples. A composable kernel generation system 200a uses a model compilation method 300b to generate models in a binary executable format using modular kernels. Although the model compilation method 300b is depicted in a particular sequence of operations, the sequence may be altered without departing from the scope of the present examples. For example, some of the operations depicted may be performed in parallel or in a different sequence that does not materially affect the operator of the process. In other examples, different components of a composable kernel generation system 200a that implement the model compilation method 300b may perform operators at substantially the same time or in a specific sequence.

In operation 302, composable kernel generation system 200a receives an input program 314 of a computation written in a high-level language. For example, the model can be written in a general purpose language and be comprised of a set of functions where each function comprises a set of operators.

In operation 304, the composable kernel generation system 200a lowers 326 the model into an intermediate representation in a first intermediate language, the intermediate representation 334 comprises a set of input variables (as represented by input 1 318, input 2 316, and input N 320), a set of output variables (as represented by output 328), and a set of operators (as represented by generator 1 338, generator 2 322, and generator N 324) that translate a set of input values corresponding to the set of input variables into a set of output values corresponding to the set of output variables. For example, the compilation system converts the program 314 into a graphical intermediate representation 334 of the model where each expression in the model has a representation in the intermediate representation 334 of the model as a set of nodes and vertices of a subgraph of the graphical intermediate representation 334 of the model.

In operation 306, the composable kernel generation system 200a determines a first set of operators and a second set of operators from the set of operators based on a selection criteria. For example, the compilation system comprises a kernel library 336 of kernels with each kernel comprising a set of operators comprising operators that may or may not correspond to a subset of the operators of the intermediate representation 334. In addition, the compilation system comprises a fallback library 220 of fallback operators comprising operators and operators corresponding to the set of operators of the intermediate representation 334. The compilation system separates into a first set of operators a subset of operators of the intermediate representation 334 on the basis of matching an operator of the intermediate representation 334 with an operator in the compilation system's kernel library 336. Operators of the intermediate representation 334 that do not belong to the first set of operators are assigned to a second set operators.

In operation 308, the composable kernel generation system 200a generates a set of optimized intermediate representations of the operators where the optimized operators are based on the first set of operators.

In operation 310, the composable kernel generation system 200a generates a set of non-optimized intermediate representations of the operators based on the second set of operators and a library of fallback operators.

For example, the compilation system selects the operators in the first set of operators based on the corresponding operators in the kernel library 336. The operators in the second set operators are selected based on the operators in the fallback library 220. In some examples, the compilation system is built to be open where new operators can be added to the kernel library 336 but there is no need to have all possible operators needed by a model in the kernel library 336 as any operators that are not found in the kernel library 336 will be found in the fallback library 220. In some examples, the operators in the first set of operators of the intermediate representation 334 are candidates for advanced optimization of the intermediate representation 334 using various methodologies including, but not limited to operator fusion, while operators in the fallback library 220 are not eligible for advanced optimization.

In operation 312, the composable kernel generation system 200a generates 332 a primitive-level representation of the model based on the set of optimized operators and the set of non-optimized operators. For example, the operators are lowered from the graph-level value-semantic intermediate representation 334 to a primitive-level buffer-semantic representation. In some examples, this transition makes lower-level optimizations like memory planning simpler. In some examples, part of the transition is splitting the executable program 330 into an initialization phase and an execution phase, putting computationally expensive setup steps into the initialization phase thereby keeping the execution phase computationally lightweight. This is because, when executing a model, usually an initialization phase is run once, and the execution phase many times.

The primitive-level representation is then encoded into a Binary Executable Format (BEF) file, which is an efficiently mappable binary format for execution during a graph runtime. From there, the runtime client loads the appropriate BEF, finds a correct entry point (models have names and can be looked up), and executes the model with the appropriate inputs. In some examples, the execution is fully asynchronous, and multiple executions can be pipelined in a straightforward manner.

In some examples, a first set of intermediate operator representations is generated by translating each operator of the first set of operators into an intermediate operator representation of each operator in a second intermediate language, determining a configuration of the set of intermediate operator representations based on a search of a set of kernels, each kernel of the set of kernels comprised of a second set of intermediate operator representations, and generating the set of optimized primitive-level buffer-semantic representations based on the configuration of the set of intermediate operator representations. In some examples, translating the operator comprises lowering code of the operator into a lower intermediate language.

In some examples, all or portions of a composable kernel generation system 200a are performed as part of a JIT process on a local device. For example, when a program that requires certain kernels is executed, the JIT compiler is invoked. Unlike traditional ahead-of-time (AOT) compilation, where all code is compiled before execution, JIT compilation defers the compilation of kernels until they are needed at runtime.

During a runtime analysis phase, a JIT compiler monitors a program's execution to determine which kernels are frequently used or are performance-critical. This runtime analysis helps the JIT compiler prioritize which kernels to compile and optimize first.

In an intermediate representation generation phase, for the kernels identified for JIT compilation, the source code or bytecode is translated into an IR. This IR is a lower-level, platform-independent code that is easier for the JIT compiler to analyze and optimize.

In an on-demand compilation phase, the JIT compiler compiles the IR of the kernels into native machine code on-demand, just before the kernels are executed for the first time. This step is performed at runtime, hence the term “Just In Time.”

In an optimization phase, the JIT compiler applies various optimization techniques to the IR or directly to the machine code to improve performance. These optimizations may include inlining, loop unrolling, dead code elimination, and others that are informed by the runtime behavior of the program. In some examples, an AI component 102 (of FIG. 1) employing models that have been trained on execution metrics 134 (of FIG. 1) as more fully described in reference to FIG. 5 and FIG. 6, is used to optimize the compilation process. The JIT compiler can use feedback from the execution metrics to learn and improve its compilation and optimization strategies over time.

In a caching phase, once a kernel is compiled into native code, it is cached in memory. Subsequent calls to the same kernel can use the cached version, avoiding the need to recompile the kernel each time it is invoked. As the program continues to run, the JIT compiler can gather more performance data and may recompile and re-optimize kernels to adapt to changing usage patterns or data sets. If certain kernels are no longer used, or if the system needs to free up resources, the JIT compiler may remove the compiled code from the cache, a process that can be part of the system's garbage collection routine.

Using a JIT compilation process with kernels allows for several advantages:
Performance Improvements: JIT compilers can optimize kernels for the specific hardware they are running on, which can lead to better performance compared to AOT-compiled code.
Flexibility: JIT compilation allows for the execution of code on different hardware without the need for recompilation since the compilation is done on the target machine.
Efficiency: Only the kernels that are actually used are compiled, which can save time and resources compared to compiling all kernels ahead of time.
Adaptability: The JIT process can adapt the optimizations based on the actual data and workload, which can lead to more efficient execution than static AOT optimizations.

FIG. 4 is a block diagram of an authoring system, in accordance with some examples. A software developer uses a kernel authoring system 400 to write kernel generators and operator generators for use by the composable kernel generation system 200a.

The kernel authoring system 400 comprises a software development environment 404 and a set of libraries 412. The software development environment 404 includes an editor 402 used to edit a kernel generator 418 and related operators. The software development environment 404 further includes a set of programming aids such as interfaces to other GPLs 410, a system constraints 406 component that provided information on the system limitations of a system that will be executing a kernel, and a debugger 408. The software development environment 404 accesses a set of libraries 412 that include a set of specialized operators 416 and a set of 414.

In some examples, the kernel authoring system 400 includes programming aids that allow for deriving shape operators by slicing value-semantic operator descriptions, and backwards versions of operators can be generated from buffer level abstractions in many cases. Many other simpler tables are also useful, e.g., the determination of whether an operator has side effects, which dtypes it supports, and the like.

In some examples, the kernel authoring system 400 provides tools that allow using formal methods to compare equivalence between multiple implementations of the same operators.

In some examples, kernel generators are based on a declarative model with explicit search-enabled meta programming features and are written in a dialect of Python that support low level semantics, typing, and allows for development of additional features.

### Machine-Learning Pipeline

FIG. 6 is a flowchart depicting a machine-learning pipeline 600, according to some examples. The machine-learning pipeline 600 may be used to generate a trained machine-learning model 602, for example a machine-learning model as used by AI component 102 of FIG. 1 to perform kernel searching and compiler optimization.

### Overview

Broadly, machine learning may involve using computer algorithms to automatically learn patterns and relationships in data, potentially without the need for explicit programming. Machine learning algorithms can be divided into three main categories: supervised learning, unsupervised learning, and reinforcement learning.
Supervised learning involves training a model using labeled data to predict an output for new, unseen inputs. Examples of supervised learning algorithms include linear regression, decision trees, and neural networks.
Unsupervised learning involves training a model on unlabeled data to find hidden patterns and relationships in the data. Examples of unsupervised learning algorithms include clustering, principal component analysis, and generative models like autoencoders.
Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks, which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Three example types of problems in machine learning are classification problems, regression problems, and generation problems. Classification problems, also referred to as categorization problems, aim at classifying items into one of several category values (for example, is this object an apple or an orange?). Regression algorithms aim at quantifying some items (for example, by providing a value that is a real number). Generation algorithms aim at producing new examples that are similar to examples provided for training. For instance, a text generation algorithm is trained on many text documents and is configured to generate new coherent text with similar statistical properties as the training data.

### Training Phases

Generating a trained machine-learning model 602 may include multiple phases that form part of the machine-learning pipeline 600, including for example the following phases illustrated in FIG. 5:
Data collection and preprocessing 502: This phase may include acquiring and cleaning data to ensure that it is suitable for use in the machine learning model. This phase may also include removing duplicates, handling missing values, and converting data into a suitable format.
Feature engineering 504: This phase may include selecting and transforming the training data 606 to create features that are useful for predicting the target variable. Feature engineering may include (1) receiving features 608 (e.g., as structured or labeled data in supervised learning) and/or (2) identifying features 608 (e.g., unstructured or unlabeled data for unsupervised learning) in training data 606.
Model selection and training 506: This phase may include selecting an appropriate machine learning algorithm and training it on the preprocessed data. This phase may further involve splitting the data into training and testing sets, using cross-validation to evaluate the model, and tuning hyperparameters to improve performance.
Model evaluation 508: This phase may include evaluating the performance of a trained model (e.g., the trained machine-learning model 602) on a separate testing dataset. This phase can help determine if the model is overfitting or underfitting and determine whether the model is suitable for deployment.
Prediction 510: This phase involves using a trained model (e.g., trained machine-learning model 602) to generate predictions on new, unseen data.
Validation, refinement or retraining 512: This phase may include updating a model based on feedback generated from the prediction phase, such as new data or user feedback.
Deployment 514: This phase may include integrating the trained model (e.g., the trained machine-learning model 602) into a more extensive system or application, such as a web service, mobile app, or IoT device. This phase can involve setting up APIs, building a user interface, and ensuring that the model is scalable and can handle large volumes of data.

FIG. 6 illustrates further details of two example phases, namely a training phase 604 (e.g., part of the model selection and trainings 506) and a prediction phase 610 (part of prediction 510). Prior to the training phase 604, feature engineering 504 is used to identify features 608. This may include identifying informative, discriminating, and independent features for effectively operating the trained machine-learning model 602 in pattern recognition, classification, and regression. In some examples, the training data 606 includes labeled data, known for pre-identified features 608 and one or more outcomes. Each of the features 608 may be a variable or attribute, such as an individual measurable property of a process, article, system, or phenomenon represented by a data set (e.g., the training data 606). Features 608 may also be of different types, such as numeric features, strings, and graphs, and may include one or more of content 612, concepts 614, attributes 616, historical data 618, and/or user data 620, merely for example.

In training phase 604, the machine-learning pipeline 600 uses the training data 606 to find correlations among the features 608 that affect a predicted outcome or prediction/inference data 622.

With the training data 606 and the identified features 608, the trained machine-learning model 602 is trained during the training phase 604 during machine-learning program training 624. The machine-learning program training 624 appraises values of the features 608 as they correlate to the training data 606. The result of the training is the trained machine-learning model 602 (e.g., a trained or learned model).

Further, the training phase 604 may involve machine learning, in which the training data 606 is structured (e.g., labeled during preprocessing operations). The trained machine-learning model 602 implements a neural network 626 capable of performing, for example, classification and clustering operations. In other examples, the training phase 604 may involve deep learning, in which the training data 606 is unstructured, and the trained machine-learning model 602 implements a deep neural network 626 that can perform both feature extraction and classification/clustering operations.

In some examples, a neural network 626 may be generated during the training phase 604, and implemented within the trained machine-learning model 602. The neural network 626 includes a hierarchical (e.g., layered) organization of neurons, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron in the neural network 626 operationally computes a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 626 may also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 604, a validation phase may be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the model may be tested on a new dataset. The testing dataset is used to evaluate the model's performance and ensure that the model has not overfitted the training data.

In prediction phase 610, the trained machine-learning model 602 uses the features 608 for analyzing query data 628 to generate inferences, outcomes, or predictions, as examples of a prediction/inference data 622. For example, during prediction phase 610, the trained machine-learning model 602 generates an output. Query data 628 is provided as an input to the trained machine-learning model 602, and the trained machine-learning model 602 generates the prediction/inference data 622 as output, responsive to receipt of the query data 628.

In some examples, the types of training data included in execution metrics 134 (of FIG. 2A) that are collected by the composable kernel generation system 200a (of FIG. 2A) during runtime 229 (of FIG. 2A) to train a trained machine-learning model 602 of the AI component 102 include, but are not limited to:

### Execution Metrics (Execution Phase Data):

Performance scores for different kernel configurations, including execution time and loading time.
Data on the efficiency of kernel execution on various hardware devices.
Metrics related to the computational resources consumed by kernels, such as CPU usage, memory usage, and I/O operations.

### Kernel Generation Data (Compilation Phase Data):

Historical data on the success rates of different kernel configurations.
Information on the parameterization choices made during kernel generation and their outcomes.
Data on the frequency and context of use for various kernel parameters and configurations.

### Kernel Authoring Data (Kernel Authoring Phase Data):

Patterns in code structure and syntax that lead to more efficient kernels.
Common errors or inefficiencies in kernel code that an AI component can learn to identify and correct.
User interactions with an SDE, such as the use of specific tools or features that aid in kernel authoring.

### Search Data (Search Phase Data):

Results of searches for optimal configurations, including the paths taken through the search space and the effectiveness of different search strategies.
The impact of AI-assisted searches on the quality and performance of the resulting kernels.

### Training and Prediction Data (Machine Learning Program Training Data):

Features extracted from kernels and their performance metrics that are relevant for training the AI model.
Historical data on kernel performance that can be used to train predictive models within the AI component.
Validation and refinement data from iterative training processes to improve the accuracy of the AI model.

### User Data (Software Development Environment Data):

Feedback from developers on the suggestions provided by the AI component.
Usage patterns of the Software Development Environment that can inform the AI component's recommendations.

### Deployment Data:

Information on how kernels perform in a production environment, which can be used to further refine the AI model.

By collecting and analyzing these types of execution data, the composable kernel generation system 200a can train the trained machine-learning model 602 used within an AI component 102 to better assist in the search and kernel authoring phases, ultimately leading to more efficient and effective kernel generation and deployment.

In some examples, the composable kernel generation system 200a collects kernel compilation data and generation data collected during a compilation phase and uses the collected compilation data and generation data to train the trained machine-learning model 602 used in the AI component 102 includes, but is not limited to:

### Compilation Time Metrics:

Duration of the compilation process for each kernel or set of kernels.
Resources used during compilation, such as CPU and memory usage.

### Intermediate Representation Data:

Characteristics of the intermediate representations generated during the lowering of high-level code to machine code.
Transformations applied to the code during the compilation stages and their effects on performance.

### Configuration and Parameterization Data:

The specific parameter values chosen for kernel generation and their impact on the compiled kernel's performance.
Frequency and effectiveness of different parameter combinations used during kernel generation.

### Optimization Outcomes:

Success rates of various optimization techniques applied during the compilation, such as loop unrolling, vectorization, and inlining.
Performance improvements achieved through specific optimizations.

### Error and Warning Logs:

Compilation errors and warnings that occur, which can be used to identify common issues and improve the robustness of the compilation process.

### Search Algorithm Data:

Paths taken through the search space when determining optimal configurations.
Effectiveness of different search strategies and heuristics used by the AI component.

### Code Generation Patterns:

Common patterns or idioms in the generated code that correlate with higher performance or efficiency.
Variations in the generated assembly or machine code for different target architectures.
   Feedback from Runtime Performance:
Data on how well the kernels perform once deployed, which can be used to adjust the compilation strategies retrospectively.

### Developer Interaction Data:

Inputs and adjustments made by developers during the kernel authoring phase that influence the compilation outcomes.
Usage patterns of compilation flags and directives provided by developers.

By collecting and analyzing this kernel generation data, the AI component can learn to predict the most effective compilation strategies for different scenarios, leading to more efficient kernel generation and potentially reducing the time and resources required for the compilation phase. This data-driven approach can significantly enhance the capabilities of the AI component in assisting with kernel generation and optimization.

In some examples, the trained machine-learning model 602 may be a generative AI model. Generative AI is a term that may refer to any type of artificial intelligence that can create new content from training data 606. For example, generative AI can produce text, images, video, audio, code, or synthetic data similar to the original data but not identical.

Some of the techniques that may be used in generative AI are:
Convolutional Neural Networks (CNNs): CNNs may be used for image recognition and computer vision tasks. CNNs may, for example, be designed to extract features from images by using filters or kernels that scan the input image and highlight important patterns.
Recurrent Neural Networks (RNNs): RNNs may be used for processing sequential data, such as speech, text, and time series data, for example. RNNs employ feedback loops that allow them to capture temporal dependencies and remember past inputs.
Generative adversarial networks (GANs): GANs may include two neural networks: a generator and a discriminator. The generator network attempts to create realistic content that can “fool” the discriminator network, while the discriminator network attempts to distinguish between real and fake content. The generator and discriminator networks compete with each other and improve over time.
Variational autoencoders (VAEs): VAEs may encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies.
Transformer models: Transformer models may use attention mechanisms to learn the relationships between different parts of input data (such as words or pixels) and generate output data based on these relationships. Transformer models can handle sequential data, such as text or speech, as well as non-sequential data, such as images or code.

In generative AI examples, the query data 628 may include text, audio, image, video, numeric, or media content prompts and the output prediction/inference data 622 includes text, images, video, audio, code, or synthetic data.

In some examples, the training phase 604 and the prediction phase 610 are performed on a distributed system such as composable kernel generation system 200a of FIG. 2A.

In some examples, one or more of the operations of the training phase 604 and the prediction phase 610 are performed on a local device as part of a JIT compilation process as more fully described in reference to FIG. 2E and FIG. 2F.

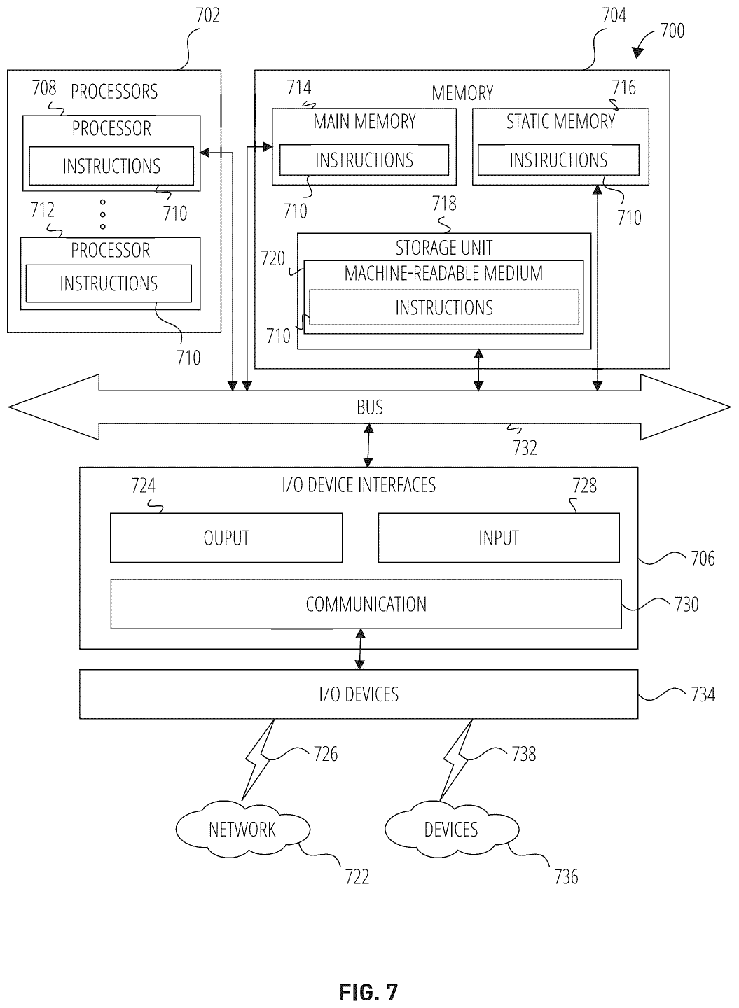

FIG. 7 is a diagrammatic representation of a machine 700 within which instructions 710 (e.g., software, a program, an application, an applet, an app, or other executable code) for causing the machine 700 to perform any one or more of the methodologies discussed herein may be executed. For example, the instructions 710 may cause the machine 700 to execute any one or more of the methods or processes described herein. The instructions 710 transform the general, non-programmed machine 700 into a particular machine 700 programmed to carry out the described and illustrated operators in the manner described. The machine 700 may operate as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 in conjunction with other components of a compiler system may operator as, but not limited to, a server, a client, computer, a personal computer (PC), a tablet computer, a laptop computer, or any machine capable of executing the instructions 710, sequentially or otherwise, that specify actions to be taken by the machine 700. Further, while a single machine 700 is illustrated, the term “machine” may also be taken to include a collection of machines that individually or jointly execute the instructions 710 to perform any one or more of the methodologies discussed herein.

The machine 700 may include one or more processors 702, memory 704, and I/O device interfaces 706, which may be configured to communicate with one another via a bus 732. In an example, the processors 702 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 708 and a processor 712 that execute the instructions 710. The term “processor” is intended to include multi-core processors that may comprise two or more independent processors (sometimes referred to as “cores”) that may execute instructions contemporaneously. Although FIG. 7 shows multiple processors 702, the machine 700 may include a single processor with a single core, a single processor with multiple cores (e.g., a multi-core processor), multiple processors with a single core, multiple processors with multiples cores, or any combination thereof.

The memory 704 includes a main memory 714, a static memory 716, and a storage unit 718, both accessible to the processors 702 via the bus 732. The main memory 704, the static memory 716, and storage unit 718 store the instructions 710 embodying any one or more of the methodologies or operators described herein. The instructions 710 may also reside, completely or partially, within the main memory 714, within the static memory 716, within a non-transitory machine-readable medium 720 within the storage unit 718, within one or more of the processors 702 (e.g., within the processor's cache memory), or any suitable combination thereof, during execution thereof by the machine 700.

The I/O device interfaces 706 couple the machine 700 to I/O devices 734. One or more of the I/O devices 734 may be a component of machine 700 or may be separate devices. The I/O device interfaces 706 may include a wide variety of interfaces to the I/O devices 734 used by the machine 700 to receive input, provide output, produce output, transmit information, exchange information, capture measurements, and so on. The specific I/O device interfaces 706 that are included in a particular machine will depend on the type of machine. It will be appreciated that the I/O device interfaces 706 the I/O devices 734 may include many other components that are not shown in FIG. 7. In various examples, the I/O device interfaces 706 may include output component interfaces 724 and input component interfaces 728. The output component interfaces 724 may include interfaces to visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input component interfaces 728 may include interfaces to alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O device interfaces 706 further include communication component interfaces 730 operable to couple the machine 700 to a network 722 or one or more devices 736 via coupling 726 and a coupling 738, respectively. For example, the communication component interfaces 730 may include an interface to a network interface component or another suitable device to interface with the network 722. In further examples, the communication component interfaces 730 may include interfaces to wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 736 may be another machine or any of a wide variety of peripheral devices (e.g., a peripheral device coupled via a USB).

The various memories (e.g., memory 704, main memory 714, static memory 716, and/or memory of the processors 702) and/or storage unit 718 may store one or more sets of instructions and data structures (e.g., software) embodying or used by any one or more of the methodologies or operators described herein. These instructions (e.g., the instructions 710), when executed by processors 702, cause various operations to implement the disclosed examples.

The instructions 710 may be transmitted or received over the network 722, using a transmission medium, via a network interface device (e.g., a network interface component included in the communication component interfaces 730) and using any one of a number of well-known transfer protocols (e.g., hypertext transfer protocol (HTTP)). Similarly, the instructions 710 may be transmitted or received using a transmission medium via the coupling 738 (e.g., a peer-to-peer coupling) to the devices 736.

Described implementations of the subject matter can include one or more features, alone or in combination as illustrated below by way of example.

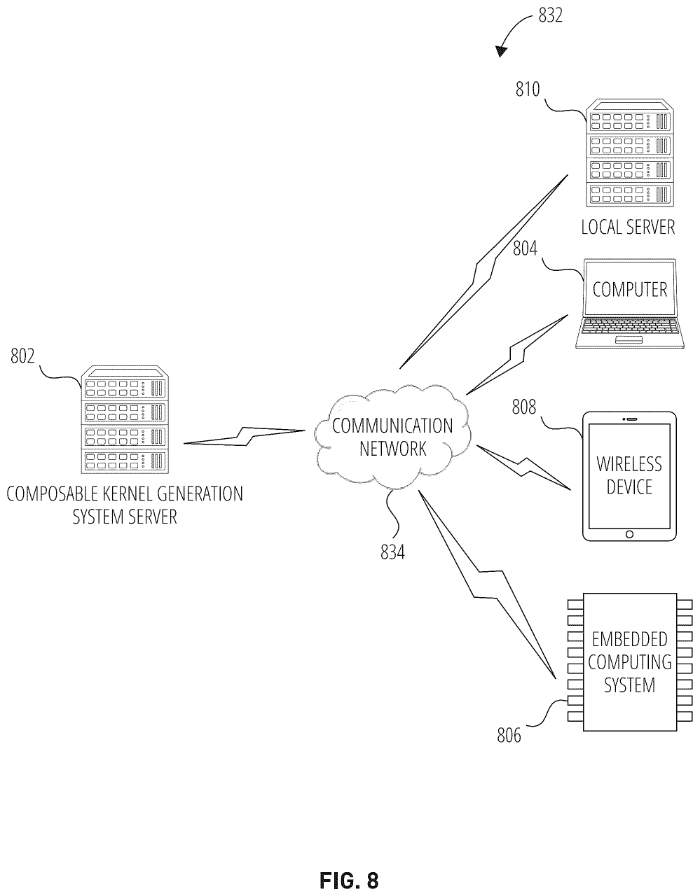

FIG. 8 is a deployment diagram for a composable kernel generation and deployment system, according to some examples.

In some examples, a composable kernel generation and deployment system comprises a composable kernel generation system server 802, that serves as a processing and management unit for kernel and objects in binary executable format generation tasks. This server is designed to handle the computations and data processing required for creating and optimizing kernels, which are components of software applications that perform specific operations or calculations.

The system also includes an array of local devices that interact with the composable kernel generation system server 802. These local devices can vary widely in their capabilities and purposes. For instance, a local server 810 may act as an intermediary, providing additional computational resources or serving as a relay point for distributing kernels to other devices within the network. A standard computer 804, such as a desktop or laptop, may be used by developers to write and test code, and to interface with the kernel generation system server 802 for compiling and retrieving optimized kernels.

Wireless devices 808, which could range from smartphones to tablets, may utilize the kernels generated by the server 802 for various applications that require on-the-fly computations, benefiting from the JIT compilation process that optimizes kernel performance based on the specific hardware characteristics of the device.

Embedded computing systems 806 represent specialized hardware that often requires highly optimized kernels due to constraints in processing power or memory. These systems can include IoT devices, automotive control systems, or industrial machinery controllers, all of which may rely on the composable kernel generation system server 802 to provide efficient kernels tailored to their unique operational requirements.

The communication network 834 connects the composable kernel generation system server 802 with these diverse local devices. The composable kernel generation system server 802 facilitates the transfer of data, code, and instructions necessary for the kernel generation and deployment process. The communication network 834 can be composed of various technologies, including wired and wireless connections, and can span across local and wide area networks to ensure seamless interaction between the composable kernel generation system server 802 and the local devices, regardless of their geographical distribution.

Through this interconnected system, the composable kernel generation system server 802 can efficiently distribute the workload, manage kernel versions, and provide updates or optimizations to the deployed kernels, ensuring that each device operates with the most effective code for its specific use case. This architecture not only maximizes the performance of individual devices but also enhances the overall efficiency and adaptability of the kernel generation and deployment process across the entire ecosystem.

In some examples, the process of creating and deploying kernels is divided into phases managed by a composable kernel generation system hosted on the composable kernel generation system server 802. During a generation phase, the composable kernel generation system is responsible for the task of constructing executable objects in a binary executable format, which are the final, runnable forms of the kernels. These executable objects are generated after a series of steps that may include receiving kernel specifications, performing optimizations, and compiling the kernels into a binary format that is suitable for execution on various hardware platforms.

In some examples, the generation phase involves not only the translation of high-level kernel code into machine-level instructions but also the application of various optimization techniques. These optimizations are tailored to enhance performance, reduce resource consumption, and ensure compatibility with the target execution environments. The composable kernel generation system server 802 leverages its computational resources to efficiently handle these tasks, producing optimized kernels and executable objects that are ready for deployment.

Once the generation phase is complete, the system transitions to the runtime phase, where the executable objects are deployed to one or more local devices. These local devices can include, but are not limited to, computers 804, wireless devices 808, embedded computing systems 806, and local servers 810. Deployment involves transferring the executable objects from the composable kernel generation system server 802 to the local devices over the communication network 834, which may consist of various network types and configurations.

During the runtime phase, the local devices execute the deployed executable objects comprised of kernels as part of their software applications. The kernels perform the specific operations they were designed for, such as data processing, mathematical computations, or any other specialized tasks. In some examples, the deployment process is designed to be seamless and efficient, providing for the local devices receive the correct versions of the kernels that are compatible with their hardware and software environments.

In some examples, the composable kernel generation system server 802 may also provide ongoing support during the runtime phase, such as monitoring kernel performance, collecting execution metrics, and potentially delivering updates or further optimizations to the kernels as needed. This continuous support ensures that the kernels remain efficient and effective throughout their operational lifespan, providing the local devices with the computational capabilities required for their respective applications.

In some examples, the executable objects deployed to local devices are not only self-contained units of execution but also come equipped with built-in analytics collection and transmission components. These analytics components serve a dual purpose: they gather data on how the kernels perform during actual runtime conditions on the local devices, and they ensure the secure and efficient transmission of these execution metrics back to the composable kernel generation system server 802. These execution metrics provide insights into the real-world performance of the kernels, allowing for a detailed understanding of their efficiency and stability across different devices and operating conditions.

For example, for a local device, the analytics component might track how quickly a kernel processes data, how much CPU time it consumes, and whether it operates within the expected memory footprint. On a wireless device, additional metrics like battery drain or network usage during kernel execution might be particularly relevant. For embedded computing systems, which are often resource-constrained, the analytics might focus on real-time performance and reliability.

Once collected, these execution metrics are communicated back to the composable kernel generation system server 802 via the communication network 834. This communication can be facilitated through various protocols and network types, ensuring compatibility and security. The composable kernel generation system server 802 then uses this data to assess the performance of the kernels and to inform future optimizations.

The feedback loop created by this process is invaluable for continuous improvement. By analyzing the execution metrics, AI components within a composable kernel generation system can learn and adapt, refining the kernel generation process to produce even more efficient and effective kernels. This ongoing cycle of deployment, data collection, analysis, and enhancement helps to evolve the kernel generation system, facilitating responsiveness to the changing demands of the local devices and the environments in which they operate.

In some examples, the local devices are equipped with the capability to perform kernel generation operations on-the-fly using a JIT compilation process. This process enables the local devices to generate executable objects comprised of optimized, runnable versions of kernels dynamically at the time they are needed during program execution, rather than relying solely on pre-compiled kernels provided by the composable kernel generation system server 802.

By enabling local devices to generate their own executable objects using JIT compilation, the composable kernel generation and deployment system 832 allows for a high degree of flexibility and responsiveness. Local devices can optimize kernels for their current workload and operating conditions, potentially achieving better performance than if they were using pre-compiled executable objects. Additionally, this approach can reduce the need for frequent communication with the composable kernel generation system server 802, which can be beneficial in scenarios where network connectivity is limited or where low latency is desired.

Example 1 is a computer-implemented method comprising: receiving, by one or more processors, a kernel generator comprising a kernel parameterization and code of a set of operators written in a general purpose programming language; for each operator of the set of operators, performing operations comprising: translating code of the each operator into an intermediate representation of the each operator in an intermediate language; determining a configuration of the each operator based on the kernel parameterization and the intermediate representation of the each operator; and generating a binary object of the each operator of a set of binary objects of the set of operators based on the configuration; and composing a kernel corresponding to the kernel generator based on the set of binary objects of the set of operations and the kernel parameterization.

In Example 2, the subject matter of Example 1 includes, wherein translating code of the each operator comprises lowering code of the each operator to a lower intermediate language.

In Example 3, the subject matter of any of Examples 1-2 includes, wherein determining the configuration of the each operator comprises: generating a set of configurations of the each operator based on the kernel parameterization and the intermediate representation of the each operator; generating an executable set of test operators based on the set of configurations; executing the set of test operators to determine a set of respective performance scores; selecting an optimal configuration of the set of configurations based on the set of respective performance scores; and determining the configuration of the each operator based on the optimal configuration.

In Example 4, the subject matter of any of Examples 1-3 includes, wherein generating the set of configurations is further based on a target machine parameterization.

In Example 5, the subject matter of any of Examples 1-4 includes, wherein the set of test operators are executed on a plurality of machines.

In Example 6, the subject matter of any of Examples 1-5 includes, wherein the performance scores include a set of an execution time and a loading time.

In Example 7, the subject matter of any of Examples 1-6 includes, wherein generating the set of test operators comprises: for each configuration of the set of configurations, performing operations comprising:

selecting a library of operators from a set of libraries based on the each configuration; and generating a test operator of the set of test operators based on the selected library and the each configuration.

In Example 8, the subject matter of any of Examples 1-7 includes, wherein the set of libraries includes a set of user-defined libraries and a set of system-defined libraries.

In Example 9, the subject matter of any of Examples 1-8 includes, wherein the operators defined in the set of libraries are stored in an intermediate language.

In Example 10, the subject matter of any of Examples 1-9 includes, wherein the operators are initially defined in a programming language other than the general purpose programming language and lowered to the intermediate language.

In Example 11, the subject matter of any of Examples 1-10 includes, caching the optimal configuration in a datastore.

In Example 12, the subject matter of any of Examples 1-11 includes, wherein the datastore is searchable based on the operator parameterization and the target machine parameterization.

In Example 13, the subject matter of any of Examples 1-12 includes, wherein determining the configuration of the operator further comprises searching the datastore based on the kernel parameterization and the target machine configuration to find the optimal configuration.

In Example 14, the subject matter of any of Examples 1-13 includes, wherein the datastore is distributed across multiple storage nodes and the searching is performed on the distributed storage nodes.

In Example 15, the subject matter of any of Examples 1-14 includes, wherein a set of runtime performance data collected from a set of executed operators during execution is stored in the datastore, each executed operator associated with a known configuration and a known operator parameterization.

In Example 16, the subject matter of any of Examples 1-15 includes, wherein the performance score is based on communications between a subset of the executed operators.

In Example 17, the subject matter of any of Examples 1-16 includes, wherein determining a configuration of the operator comprises: determining a configuration using a machine learning model trained on a set of runtime performance data collected from a set of executed operators during execution, each executed operator associated with a known configuration and a known parameterization.

In Example 18, the subject matter of any of Examples 1-17 includes, wherein operations of translating code of the operator, determining the configuration, generating the binary object of the operator, and composing the kernel are performed on two or more machines.

In Example 19, the subject matter of any of Examples 1-18 includes, wherein the kernel is stored in a datastore accessible through a network.

In Example 20, the subject matter of any of Examples 1-19 includes, wherein the kernel is combinable with other kernels in a kernel library.

In Example 21, the subject matter of any of Examples of 1-20 includes, wherein a Just In Time (JIT) compiler is used to perform one or more operations of a compilation phase on a local device.

Example 22 is at least one machine-readable medium including instructions that, when executed by processing circuitry, cause the processing circuitry to perform operations to implement any of Examples 1-21.

Example 23 is an apparatus comprising means to implement any of Examples 1-21.

Example 24 is a system to implement any of Examples 1-21.

Example 25 is a method to implement any of Examples 1-21.

Example 26 is a computer implemented method comprising: receiving, by one or more processors, an input model of a computation, the model written in a high-level language; translating, by the one or more processors, the model into an intermediate representation in a first intermediate language, the intermediate representation comprising a set of input variables, a set of output variables, and a set of operators that translate a set of input values corresponding to the set of input variables into a set of output values corresponding to the set of output variables; determining, by the one or more processors, a first set of operators and a second set of operators from the set of operators based on a selection criteria; generating, by the one or more processors, a set of optimized primitive-level buffer-semantic representations of the first set of operators; generating, by the one or more processors, a set of non-optimized primitive-level buffer-semantic representations of the second set of operators and a library of fallback operators; and composing an executable model corresponding to the input model based on the set of optimized primitive-level buffer-semantic representations and the set of non-optimized primitive-level buffer-semantic representations, the executable model in a binary executable format.

In Example 27, the subject matter of Example 26 includes, wherein generating a set of optimized operators comprises: generating a first set of intermediate operator representations by translating each operator of the first set of operators into an intermediate representation of the each operator in a second intermediate language; determining a configuration of the set of intermediate representations of the set of operators based on a search of a set of kernels, each kernel of the set of kernels comprised of a second set of intermediate representations of operators; and generating the set of optimized primitive-level buffer-semantic representations based on the configuration of the set of intermediate operator representations.

In Example 28, the subject matter of any of Example 26-27 includes, wherein translating each operator of the first set of operators into an intermediate representation of the each operator comprises lowering code of the each operator to a lower intermediate language.

In Example 29, the subject matter of any of Example 26-28 includes, wherein translating the model into an intermediate representation comprises lowering code of the model to a lower intermediate language.

In Example 30, the subject matter of any of Examples 26-29 includes, wherein the configuration comprises a fusion of two or more of the intermediate operator representations.

Example 31 is at least one machine-readable medium including instructions that, when executed by processing circuitry, cause the processing circuitry to perform operations to implement of any of Examples 26-29.

Example 32 is an apparatus comprising means to implement any of Examples 26-29.

Example 33 is a system to implement of any of Examples 26-29.

Example 34 is a method to implement of any of Examples 26-29. A “carrier signal” refers to any intangible medium that is capable of storing, encoding, or carrying instructions for execution by the machine, and includes digital or analog communications signals or other intangible media to facilitate communication of such instructions. Instructions may be transmitted or received over a network using a transmission medium via a network interface device.

A “client device” refers to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

A “communication network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

A “machine-readable medium” refers to both machine-storage media and transmission media. Thus, the terms include both storage devices/media and carrier waves/modulated data signals. The terms “machine-readable medium,” “machine-readable medium” and “device-readable medium” mean the same thing and may be used interchangeably in this disclosure.

A “machine-storage medium” refers to a single or multiple storage devices and/or media (e.g., a centralized or distributed database, and/or associated caches and servers) that store executable instructions, routines and/or data. The term includes, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at some of which are covered under the term “signal medium.”

A “processor” refers to any circuit or virtual circuit (a physical circuit emulated by logic executing on an actual processor) that manipulates data values according to control signals (e.g., “commands”, “op codes”, “machine code”, and so forth) and which produces associated output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

A “signal medium” refers to any intangible medium that is capable of storing, encoding, or carrying the instructions for execution by a machine and includes digital or analog communications signals or other intangible media to facilitate communication of software or data. The term “signal medium” may be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

A “kernel” or “microkernel” are implementations of an algorithm that does computation against memory objects like memory buffers of a certain layout. The two terms may be used interchangeably, but “microkernel” tends to connote a small operation (e.g., memset, dot product or reduction) within a larger operator kernel implementation. Algorithmically interchangeable/equivalent/replaceable kernels are sometimes referred to as “codelets” in literature.

A “kernel generator” is a meta program that is parameterized and is executed to generate a non-parametric implementation of a kernel or microkernel. Fixed kernel implementations (e.g., a panel dot product implemented in assembly) are a degenerate case of a generator with no parameters.

A “kernel interface declaration” is a declaration of kernel or microkernel that applies to multiple implementations of a kernel or microkernel. Kernels and microkernels may be implemented multiple times in multiple different ways. An interface declaration can stand alone from the implementations, allowing clients and implementations to be type checked.

A “kernel generator parameter argument” refers to a value that a kernel or a microkernel is allowed to act on. A kernel generator is a meta program that generates a kernel, and “parameters” are the values that this meta program is allowed to act on.

A “kernel generator parameter result” is a value returned by a kernel generator to its invoker as parameters, allowing them to adapt to behavior in the generated sub-kernel. For example, a panel dot product generator could return “I processed a 3×5 panel of memory”, which causes the invoking for loop to step by 3 and 5 on each dimension.

A “kernel generator constraint” is a constraint indicating limitations on parameters of a kernel or microkernel, e.g., “this implementation only works with dtype=float32”, or “this only works on machines with X86 VNNI extension”, this “works for sizes modulo 128” etc.—Kernel generators are allowed to be partial operators from the interface declaration to a concrete implementation. Constraints are upward propagated from kernel implementations out to the operator graph.

A “kernel argument” is a Static Single Assignment (SSA) argument value used for: buffers and other user defined types for structured abstractions over memory, like linear memory, N-dimensional tensors with layouts, and other higher level data types like trees and tables; the values corresponding to op attributes in the tensor graph level, while they may be modeled as constants there, they are dynamic values for the runtime implementation of the kernel; and very small micro kernels at the bottom of the stack (e.g., add two integers) use arguments for their inputs.

A “kernel result” is a SSA result value used for: dynamically allocated result buffers, e.g., those that have data dependent shapes; and very small micro kernels at the bottom of the stack (e.g., add two integers) use results for their outputs.

Changes and modifications may be made to the disclosed examples without departing from the scope of the present disclosure. These and other changes or modifications are intended to be included within the scope of the present disclosure, as expressed in the following claims.

What is claimed is:

1. A computer-implemented method comprising:
receiving, by one or more processors, a kernel generator comprising a kernel parameterization and code of a set of operators written in a general purpose programming language;
for each operator of the set of operators, performing operations comprising:
translating code of the each operator into an intermediate representation of the each operator in an intermediate language;
determining a configuration of the each operator based on the kernel parameterization and the intermediate representation of the each operator; and
generating a binary object of the each operator of a set of binary objects of the set of operators based on the configuration; and
composing a kernel corresponding to the kernel generator based on the set of binary objects of the set of operations and the kernel parameterization.

2. The computer-implemented method of claim 1, wherein translating code of the each operator comprises lowering code of the each operator to a lower intermediate language.

3. The computer-implemented method of claim 1, wherein determining the configuration of the each operator comprises:
generating a set of configurations of the each operator based on the kernel parameterization and the intermediate representation of the each operator;
generating an executable set of test operators based on the set of configurations;
executing the set of test operators to determine a set of respective performance scores;
selecting an optimal configuration of the set of configurations based on the set of respective performance scores; and
determining the configuration of the each operator based on the optimal configuration.

4. The computer-implemented method of claim 3, wherein generating the set of configurations is further based on a target machine parameterization.

5. The computer-implemented method of claim 3, wherein the set of test operators are executed on a plurality of machines.

6. The computer-implemented method of claim 3, wherein the performance scores include a set of an execution time and a loading time.

7. The computer-implemented method of claim 3, wherein generating the set of test operators comprises:
for each configuration of the set of configurations, performing operations comprising:
selecting a library of operators from a set of libraries based on the each configuration; and
generating a test operator of the set of test operators based on the selected library and the each configuration.

8. A computing apparatus comprising:
one or more processors; and
a memory storing instructions that, when executed by the one or more processors, cause the computing apparatus to perform operations comprising:
receiving, by one or more processors, a kernel generator comprising a kernel parameterization and code of a set of operators written in a general purpose programming language;
for each operator of the set of operators, perform operations comprising:
translating code of the each operator into an intermediate representation of the each operator in an intermediate language;
determining a configuration of the each operator based on the kernel parameterization and the intermediate representation of the each operator; and
generating a binary object of the each operator of a set of binary objects of the set of operators based on the configuration; and
composing a kernel corresponding to the kernel generator based on the set of binary objects of the set of operations and the kernel parameterization.

9. The computing apparatus of claim 8, wherein translating code of the each operator comprises lowering code of the each operator to a lower intermediate language.

10. The computing apparatus of claim 8, wherein determining the configuration of the each operator comprises:
generating a set of configurations of the each operator based on the kernel parameterization and the intermediate representation of the each operator;
generating an executable set of test operators based on the set of configurations;
executing the set of test operators to determine a set of respective performance scores;
selecting an optimal configuration of the set of configurations based on the set of respective performance scores; and
determining the configuration of the each operator based on the optimal configuration.

11. The computing apparatus of claim 10, wherein generating the set of configurations is further based on a target machine parameterization.

12. The computing apparatus of claim 10, wherein the set of test operators are executed on a plurality of machines.

13. The computing apparatus of claim 10, wherein the performance scores include a set of an execution time and a loading time.

14. The computing apparatus of claim 10, wherein generating the set of test operators comprises:
for each configuration of the set of configurations, performing operations comprising:
selecting a library of operators from a set of libraries based on the each configuration; and
generating a test operator of the set of test operators based on the selected library and the each configuration.

15. A machine-storage medium storing instructions that when executed by a computer, cause the computer to:
receive, by one or more processors, a kernel generator comprising a kernel parameterization and code of a set of operators written in a general purpose programming language;
for each operator of the set of operators, perform operations comprising:
translate code of the each operator into an intermediate representation of the each operator in an intermediate language;
determine a configuration of the each operator based on the kernel parameterization and the intermediate representation of the each operator; and
generate a binary object of the each operator of a set of binary objects of the set of operators based on the configuration; and
compose a kernel corresponding to the kernel generator based on the set of binary objects of the set of operations and the kernel parameterization.

16. The machine-storage medium of claim 15, wherein translating code of the each operator comprises lower code of the each operator to a lower intermediate language.

17. The machine-storage medium of claim 15, wherein determining the configuration of the each operator comprises:
generate a set of configurations of the each operator based on the kernel parameterization and the intermediate representation of the each operator;
generate an executable set of test operators based on the set of configurations;
execute the set of test operators to determine a set of respective performance scores;
select an optimal configuration of the set of configurations based on the set of respective performance scores; and
determine the configuration of the each operator based on the optimal configuration.

18. The machine-storage medium of claim 17, wherein generating the set of configurations is further based on a target machine parameterization.

19. The machine-storage medium of claim 17, wherein the set of test operators are executed on a plurality of machines.

20. The machine-storage medium of claim 17, wherein the performance scores include a set of an execution time and a loading time.
